(19) United States
(12) Patent Application Publication
(10) Pub. No.: US 2026/0015520 A1
(43) Pub. Date: Jan. 15, 2026

(54) POLYESTER-BASED SHRINK FILM

(71) Applicants: C.I. TAKIRON Corporation, Osaka (JP); Bonset America Corporation, Browns Summit, NC (US)

(72) Inventors: Takuma KANEKO, Osaka (JP); Shuta YUGE, Osaka (JP); Tatsuya IRIFUNE, Osaka (JP); Ryuma UMINO, Osaka (JP)

(21) Appl. No.: 19/333,346

(22) Filed: Sep. 19, 2025

Related U.S. Application Data
(63) Continuation of application No. PCT/JP2024/012579, filed on Mar. 28, 2024.

(30) Foreign Application Priority Data
Mar. 29, 2023 (JP) 2023-053383

(51) Int. Cl. C09D 167/00

(52) U.S. Cl. CPC C09D 167/00

(57) ABSTRACT

Provided is a heat-shrinkable polyester film having a predetermined heat shrinkage ratio and the like in a main shrinkage direction and the like as measured using a motion capture device. It is a heat-shrinkable polyester film having a predetermined heat shrinkage ratio obtained using a motion capture device, in which when two measurement positions are set in the main shrinkage direction, the interval between the two measurement positions is designated as L, and the interval between the two measurement positions measured using a motion capture device after heat shrinkage is designated as L′1, the heat shrinkage ratio (temperature: 70° C. to 98° C., time: 1 to 60 seconds) in the main shrinkage direction obtained based on the distances of L1 and L′1 and the like is 20% or more.

### CROSS-REFERENCE TO RELATED APPLICATIONS

This application claims the benefit of priority and is a Continuation application of the prior International Patent Application No. PCT/JP2024/012579, with an international filing date of Mar. 28, 2024, which designated the United States, and is related to the Japanese Patent Application No. 2023-053383, filed Mar. 29, 2023, the entire disclosures of all applications are expressly incorporated by reference in their entirety herein.

### TECHNICAL FIELD

The present invention relates to a heat-shrinkable polyester film (sometimes called as a polyester-based shrink film or the like).

More particularly, the invention relates to a heat-shrinkable polyester film having a predetermined heat shrinkage ratio and the like that are measured quickly and accurately using a motion capture device.

### BACKGROUND ART

Conventionally, heat-shrinkable films have been widely used as base material films for labels on PET bottles and the like. In particular, polyester resins have excellent transparency and strength and are widely used. These heat-shrinkable films are caused to undergo heat shrinkage by passing through a tunnel that generates hot air or steam, and are fitted on containers; however, shrinkage differences (unevenness) would occur during heat shrinkage, causing the occurrence of wrinkles and color unevenness.

Thus, various heat-shrinkable polyester films for preventing the occurrence of wrinkles and the occurrence of color unevenness due to shrinkage differences (unevenness) produced during heat shrinkage, have been proposed.

For example, a heat-shrinkable polyester film obtained by controlling the proportion of alcohol components other than ethylene glycol, or strictly controlling the amount of a naphthalenedicarboxylic acid component in all acid components or the blending amount of an alkali metal salt of sulfobenzenedicarboxylic acid, has been proposed (see Patent Document 1).

More specifically, the heat-shrinkable polyester film is characterized in that the proportion (A mol %) of acid components other than terephthalic acid in all acid components of the polyester resin and the proportion (B mol %) of alcohol components other than ethylene glycol in all alcohol components of the polyester resin are in the range of 5 mol %≤A+B≤40 mol %, and the polyester resin contains 1 mol % to 30 mol % of a naphthalenedicarboxylic acid component, and 0.3 mol % to 3 mol % of an alkali metal salt of sulfobenzenedicarboxylic acid in all the acid components.

It is configured that the heat shrinkage ratio of such a polyester film is preferably 5% or more in the longitudinal direction of the film when immersed in hot water at a temperature of 60° C. for a time of 60 seconds, and is preferably 30% or more when immersed in hot water at a temperature of 80° C. for a time of 60 seconds.

Furthermore, a heat-shrinkable polyester film has been proposed, in which the blending amount of an amorphous component in all polyester resin components is strictly controlled, and at the same time, the hot water heat shrinkage ratios at 80° C. and 90° C. in the film longitudinal direction and the hot water heat shrinkage ratio at 90° C. in the film width direction are limited (see Patent Document 2).

More specifically, it is a heat-shrinkable polyester film which contains ethylene terephthalate as a main constituent component and contains one or more monomer components that would become amorphous components in all the polyester resin components, the total sum of which is 15 mol % or more.

Then, the polyester film is characterized in that the hot water heat shrinkage ratio in the film longitudinal direction is 30% or more at a treatment temperature of 80° C. for a treatment time of 10 seconds and is 40% or more at a treatment temperature of 90° C. for a treatment time of 10 seconds, and the hot water shrinkage ratio in the film width direction is 10% or less at 90° C. for a treatment time of 10 seconds.

Furthermore, a heat-shrinkable polyester film has been proposed, in which the shrinkage ratio in one direction and heat shrinkage ratio in a direction perpendicular thereto are specified, and at the same time, the average heat shrinkage rate coefficient in a temperature range of 70° C. to 120° C. is within a predetermined range (see Patent Document 3).

More specifically, it is a heat-shrinkable polyester film, which is a homopolymer of polyethylene terephthalate, or a copolymer configured to contain a dicarboxylic acid component other than terephthalic acid, and/or a diol component other than ethylene glycol, and/or an oxycarboxylic acid and the like.

The heat-shrinkable polyester film is characterized in that the heat shrinkage ratio in at least one direction is 30% or more, and the average heat shrinkage rate coefficient at least in that direction in a temperature range of 70° C. to 120° C. is within the range of 0.1 to 0.5%/sec·° C.

Furthermore, a shrink label has been proposed, in which the maximum heat shrinkage rate measured under predetermined conditions is specified (see Patent Document 4).

More specifically, it is a heat-shrinkable shrink label, which has at least one film layer containing a polylactic acid polymer as an essential component, and a print layer.

The film is characterized in that the heat shrinkage ratio in the main orientation direction after 1 second from the start of heat shrinkage in hot water at 75° C. is 3% to 23%, and the heat shrinkage ratio in the main orientation direction at 90° C. for 10 seconds is 40% to 84%.

Alternatively, the film is characterized in that the maximum heat shrinkage rate in the main orientation direction in hot water at 70° C. is 7 to 40%/sec, and the heat shrinkage ratio in the main orientation direction at 90° C. for 10 seconds is 40% to 84%.

### CITATION LIST

### Patent Document

Patent Document 1: JP 08-027259 A (claims and the like)
Patent Document 2: JP 2007-016120 A (claims and the like)
Patent Document 3: JP 08-323859 A (claims and the like)
Patent Document 4: JP 2008-001098 A (claims and the like)

### DISCLOSURE OF THE INVENTION

### Problem to be Solved by the Invention

However, with regard to the heat-shrinkable films described in Patent Documents 1 and 2, although the heat shrinkage ratio at a predetermined temperature in a predetermined shrinkage direction is limited to be within a predetermined range, after the film is immersed in hot water, it is necessary to remove the film from the hot water and make measurement, so that uneven heat distribution and the like are likely to occur, and the variations in the measured values would become large.

Therefore, it is difficult to obtain a polyester film having a desired heat shrinkage ratio from a polyester film having a heat shrinkage ratio measured in this way, and there are cases in which the heat shrinkage ratio characteristics would not be managed quickly and precisely.

Therefore, in particular, in the case of PET bottles and the like having a complex shape, in which the bottle diameter of the body part is not uniform, and the horizontal cross-sectional shape of the body part is not circular in some parts, since the heat shrinking property is likely to be non-uniform, there is a problem that it is extremely difficult to suppress the occurrence of fine wrinkles.

Furthermore, with regard to the heat-shrinkable film described in Patent Document 3, although the amount of change in the heat shrinkage ratio with respect to time is specified, it is intended to specify the heat shrinkage rate coefficient (%/(sec·° C.)) averaged before and after heat shrinkage, and there is no intention of measuring the heat shrinkage rate (mm/sec) from before heat shrinkage until a predetermined time, as well as the maximum value thereof.

For that reason, the heat shrinkage rate (mm/sec) could not be accurately measured at a timing when the heat-shrinkable film undergoes a large change in a short period of time during heat shrinkage.

Furthermore, with regard to the shrink label described in Patent Document 4, although the heat shrinkage ratio (%) after 1 second from the start of heat shrinkage is specified, this heat shrinkage ratio is a time-limited heat shrinkage ratio, and there is no intention given to shrink labels that have different timings for heat shrinkage.

In addition, although the maximum heat shrinkage rate (%/sec) is also mentioned, this is a measurement of the actual instantaneous heat shrinkage rate obtained when measured at an interval of 0.1 seconds, and there is no intention of measuring the maximum value of the heat shrinkage rate (mm/sec) from before heat shrinkage until a predetermined time.

Therefore, when converted to a maximum value of the heat shrinkage rate from before heat shrinkage until a predetermined time, the heat shrinkage rate is limited to a very narrow range.

Thus, the inventors of the present invention found that, by measuring the heat shrinkage ratio in the main shrinkage direction or the like using a motion capture device, and controlling the value thereof, the heat shrinkage characteristics could be managed quickly and precisely, thus completing the present invention.

That is, it is an object of the present invention to provide a heat-shrinkable polyester film having a predetermined heat shrinkage ratio in a main shrinkage direction or the like, which is measured quickly and accurately using a predetermined simple measuring method.

### Means for Solving Problem

The present invention is a heat-shrinkable polyester film having a predetermined heat shrinkage ratio obtained using a motion capture device.

There is provided a heat-shrinkable polyester film in which, when two measurement positions are set in a TD direction that is a main shrinkage direction of the heat-shrinkable polyester film as an object to be measured, an interval between the two measurement positions is designated as L1, and an interval between the two measurement positions after causing the heat-shrinkable polyester film to undergo heat shrinkage, the distance being measured using a motion capture device, is designated as L′1, a heat shrinkage ratio (temperature: 70° C. to 98° C., time: 1 to 60 seconds) in a main shrinkage direction of the heat-shrinkable polyester film as calculated based on the following Formula (1) is 20% or more, and the above-mentioned problems could be solved.

$$Heat shrinkage ratio in TD direction ( \% ) = ( L 1 - {L}^{′} 1 ) / L 1 \times 100 \qquad ( 1 )$$

That is, the heat shrinkage ratio at a predetermined location could be calculated quickly and accurately by using a motion capture device and utilizing corresponding inertial sensors and infrared light to measure the distance traveled by the predetermined location.

Furthermore, upon configuring the heat-shrinkable polyester film of the present invention, it is preferable that a standard deviation of the heat shrinkage ratio is 15% or less.

It is because, by controlling the standard deviation of the heat shrinkage ratio in this way, the heat shrinkage ratio of the heat-shrinkable polyester film could be controlled more precisely.

Furthermore, upon configuring the heat-shrinkable polyester film of the present invention, it is preferable that a thickness of the heat-shrinkable polyester film is within a range of 10 to 200 μm, and a difference between a maximum value of the thickness and an average value of the thickness is 10 μm or less.

By controlling the thickness of the heat-shrinkable polyester film in this way, the difference between the maximum value of the thickness in the TD direction and the average value of the thickness becomes small, and the heat shrinkage ratio in the TD direction could be controlled more quickly and precisely.

Furthermore, upon configuring the heat-shrinkable polyester film of the present invention, it is preferable that two measurement positions are set at a plurality of sites, and an average value of heat shrinkage ratios in the TD direction obtained at the plurality of sites is the heat shrinkage ratio in the TD direction.

By calculating the heat shrinkage ratio in the TD direction at a plurality of sites in this way, the heat shrinkage ratio in the TD direction could be controlled more quickly and precisely.

Furthermore, upon configuring the heat-shrinkable polyester film of the present invention, it is preferable that the motion capture device is an image-type motion capture device detecting information from a predetermined marker.

By selecting and using an image-type motion capture device from among various types of motion capture devices in this way, the position of the predetermined marker could be efficiently calculated, and the heat shrinkage ratio could be measured quickly and accurately.

Furthermore, upon configuring the heat-shrinkable polyester film of the present invention, it is preferable that the motion capture device includes a camera for recording the state of heat shrinkage of the heat-shrinkable polyester film.

By also taking into consideration image data showing the state of heat shrinkage captured by a camera in this way, the state of heat shrinkage in the TD direction could be correctly checked, and ultimately, the heat shrinkage ratio in the TD direction and the like could be measured more quickly and accurately.

Furthermore, upon configuring the heat-shrinkable polyester film of the present invention, it is preferable that the heat shrinkage ratio of the heat-shrinkable polyester film is based on at least one heat shrinking device selected from a constant temperature bath, a steam bath, a hot water bath, a fluorine-containing liquid bath, and an infrared ray irradiating apparatus.

By making measurements using such a heat shrinking device, the heat shrinkage ratio could be controlled more quickly, more precisely, and more simply, according to the use applications and the like of the heat-shrinkable polyester film.

Furthermore, upon configuring the heat-shrinkable polyester film of the present invention, it is preferable that a direction orthogonally intersecting a main shrinkage direction of the heat-shrinkable polyester film as an object to be measured is designated as MD direction, a heat shrinkage ratio in the MD direction is measured using a motion capture device at the same time as measuring the heat shrinkage ratio in the TD direction, and the heat shrinkage ratio in the MD direction has a value within a range of −5% to 5%.

By simultaneously measuring the heat shrinkage ratio in the MD direction using a motion capture device in this way, the heat shrinkage characteristics at the time of actually using the heat-shrinkable polyester film could be controlled according to the use applications and the like of the heat-shrinkable polyester film.

Furthermore, upon configuring the heat-shrinkable polyester film of the present invention, it is preferable that a calibration curve showing relations of a heat shrinkage temperature and a heat shrinkage time in the main shrinkage direction of the heat-shrinkable polyester film as an object to be measured, to the heat shrinkage ratio in the TD direction, is prepared in advance, the calibration curve and the heat shrinkage ratio obtained based on the above-described Formula (1) are compared and verified, and the heat shrinkage ratio obtained based on the Formula (1) has a value within ±10% of the heat shrinkage ratio in the TD direction obtained from the calibration curve.

By comparing the measured heat shrinkage ratio with the calibration prepared in advance, a heat-shrinkable polyester film having a heat shrinkage ratio and the like that are excellently reproducible could be obtained more quickly and more precisely even when a motion capture device is used.

### BRIEF DESCRIPTION OF DRAWINGS

FIGS. 1A to 1C are each a drawing for explaining the morphology of a heat-shrinkable polyester film;

FIGS. 2A to 2C are each a drawing for explaining a method for measuring a heat shrinkage ratio of the heat-shrinkable polyester film by using a motion capture device or the like;

FIGS. 3A and 3B are each a drawing for explaining the positional movement of a predetermined marker associated with heat shrinkage of the heat-shrinkable polyester film;

FIGS. 4A and 4B are each a drawing provided to explain a method for measuring a heat shrinkage rate of the heat-shrinkable polyester film by using a motion capture device or the like;

FIGS. 5A to 5C are each a drawing provided to explain a configuration example of a fixing jig used in measuring the heat shrinkage rate using a motion capture device;

FIGS. 6A and 6B are each a drawing provided to explain the heat shrinkage rate, the heat shrinkage ratio rate, and the like;

FIG. 7 is a drawing provided to explain the relation of the distance change (mm) of a predetermined section to time (seconds) in the heat-shrinkable polyester films of Examples 1 and 2 and Comparative Examples 2 and 3;

FIGS. 8A and 8B are each a drawing provided to explain the relation of the heat shrinkage rate (mm/sec) to time (seconds) in the heat-shrinkable polyester films of Examples 1 and 2, and FIG. 8C is a drawing provided to explain the relation of the heat shrinkage ratio rate (%/sec) to time;

FIGS. 9A and 9B are each a drawing provided to explain the relation of the heat shrinkage rate (mm/sec) to time (seconds) in the heat-shrinkable polyester films of Comparative Examples 2 and 3, and FIG. 9C is a drawing provided to explain the relation of the heat shrinkage ratio rate (%/sec) to time;

FIG. 10A is a drawing provided to explain the relation of the intermediate heat shrinkage rate (mm/sec) to time (seconds) in the heat-shrinkable polyester film of Example 1, and FIG. 10B is a drawing provided to explain the relation of the intermediate heat shrinkage ratio rate (%/sec) to time;

FIG. 11A is a drawing provided to explain the relation of the intermediate heat shrinkage rate (mm/sec) to time (seconds) in the heat-shrinkable polyester film of Example 2, and FIG. 11B is a drawing provided to explain the relation of the intermediate heat shrinkage ratio rate (%/sec) to time;

FIG. 12A is a drawing provided to explain the relation of the intermediate heat shrinkage rate (mm/sec) to time (seconds) in the heat-shrinkable polyester film of Comparative Example 2, and FIG. 12B is a drawing provided to explain the relation of the intermediate heat shrinkage ratio rate (%/sec) to time;

FIG. 13A is a drawing provided to explain the relation of the intermediate heat shrinkage rate (mm/sec) to time (seconds) in the heat-shrinkable polyester film of Comparative Example 3, and FIG. 13B is a drawing provided to explain the relation of the intermediate heat shrinkage ratio rate (%/sec) to time;

FIG. 14A is a drawing for explaining a plurality of measurement samples (W, C, and E) collected along the TD direction from a roll-shaped heat-shrinkable polyester film, and FIG. 14B is a drawing provided to explain a state in which a motion capture device is attached to one of the measurement samples (W, C, and E);

FIG. 15 is a drawing provided to explain, for Example 1 (line A) and Comparative Example 1 (line B), the relation between the immersion time when the film is immersed in hot water at 95° C. for 1 to 20 seconds, and the heat shrinkage ratio (%) in the TD direction measured using a motion capture device;

FIG. 16 is a drawing provided to explain the relation between the thickness (μm) of the heat shrinkable polyester film and the heat shrinkage ratio (%) in the TD direction measured using a motion capture device when the film is immersed in hot water at 95° C. for 20 seconds;

FIG. 17A is a drawing (photograph) showing the external appearance state of a cylindrical-shaped label corresponding to Example 1 when no wrinkles have occurred, and FIGS. 17B to 17D are drawings that enlarge regions P, Q, and R, respectively, in the external appearance shown in FIG. 17A; and

FIG. 18A is a drawing (photograph) showing the external appearance state of a cylindrical-shaped label corresponding to Comparative Example 1 when wrinkles have occurred, and FIGS. 18B to 18D are drawings that enlarge regions S, T, and U, respectively, in the external appearance shown in FIG. 18A.

### BEST MODE(S) FOR CARRYING OUT THE INVENTION

### First Embodiment

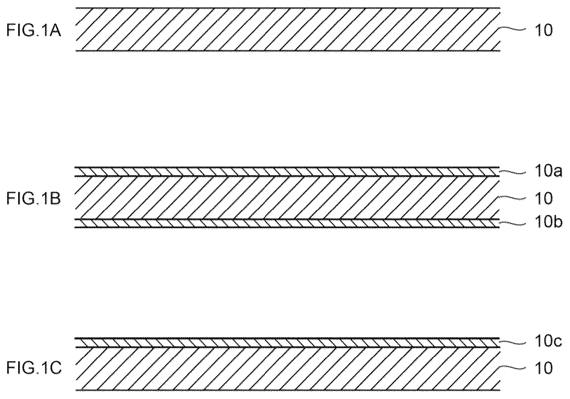

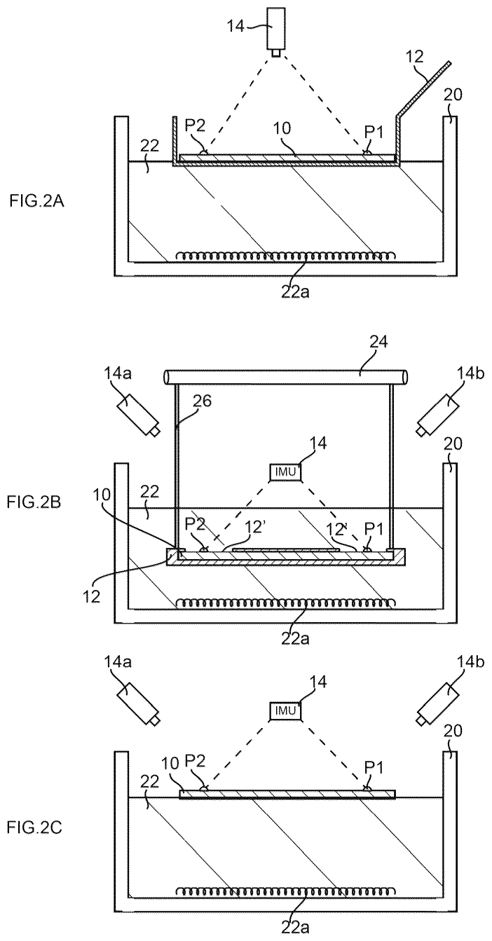

A first embodiment is a heat-shrinkable polyester film 10 shown as an example in FIGS. 1A to 1C, and as shown in FIGS. 2A to 2C, it is a heat-shrinkable polyester film having a predetermined heat shrinkage ratio obtained using a motion capture device 14.

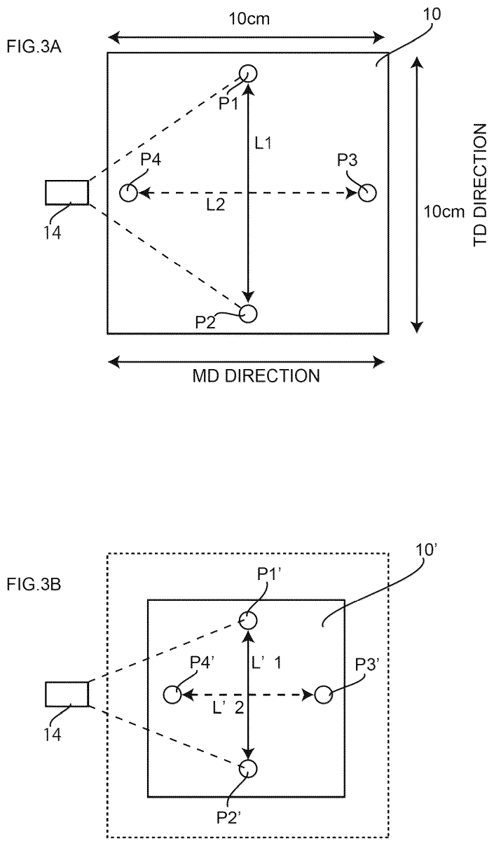

Further, it is a heat-shrinkable polyester film in which, as shown in FIGS. 3A and 3B, when two measurement positions are set in a TD direction that is a main shrinkage direction of the heat-shrinkable polyester film as an object to be measured, an interval between the two measurement positions is designated as L1, and an interval between the two measurement positions after causing the heat-shrinkable polyester film to undergo heat shrinkage, the distance being measured using a motion capture device, is designated as L′1, a heat shrinkage ratio (temperature: 70° C. to 98° C., time: 1 to 60 seconds) in a main shrinkage direction of the heat-shrinkable polyester film as calculated based on the following Formula (1) is 20% or more.

$$Heat shrinkage ratio in TD direction ( \% ) = ( L 1 - {L}^{′} 1 ) / L 1 \times 100$$

Hereinafter, the configuration and the like of the heat-shrinkable polyester film of the first embodiment will be specifically described in divided sections, with reference to the drawings as appropriate.

### 1. Polyester Resin

There is no limitation on the type of the polyester resin constituting the heat-shrinkable polyester film of the first embodiment; however, it is preferable that the polyester resin is usually a polyester resin formed from a polyalcohol and a dicarboxylic acid, a polyester resin formed from a polyalcohol and a hydroxycarboxylic acid, a polyester resin formed from a polyalcohol, a dicarboxylic acid, and a hydroxycarboxylic acid, or a mixture of these polyester resins.

Here, the polyalcohol as a compound component of the polyester resin would be at least one diol of an aliphatic diol such as ethylene glycol, diethylene glycol, propanediol, butanediol, neopentyl glycol, or hexanediol; an alicyclic diol such as 1,4-hexanedimethanol; an aromatic diol; and the like.

Therefore, among these, ethylene glycol, diethylene glycol, and 1,4-hexanedimethanol in particular are preferred.

Furthermore, it is more preferable to use a mixture including at least ethylene glycol as the polyalcohol.

By limiting the type of the polyalcohol, which is one of the polymerizable components of the polyester resin, in this way, the proportion of an amorphous portion can be adjusted, and satisfactory fittability can be obtained.

When preparing a mixture including a predetermined amount of ethylene glycol, it is preferable to use at least one other polyalcohol such as a diol having an alicyclic structure, such as 1,4-cyclohexanedimethanol; an aliphatic diol such as diethylene glycol, propanediol, butanediol, neopentyl glycol, or hexanediol; or an aromatic diol in combination, as a polyalcohol other than ethylene glycol.

It is because, by using such a polyalcohol, the polyalcohol would be appropriately reacted with a polyvalent carboxylic acid, and a non-crystalline polyester resin in which at least the crystallinity/amorphousness is controlled is likely to be obtained.

Furthermore, the dicarboxylic acid as a compound component of the same polyester resin would be at least one of a fatty acid dicarboxylic acid such as adipic acid, sebacic acid, or azelaic acid; an aromatic dicarboxylic acid such as terephthalic acid, naphthalenedicarboxylic acid, or isophthalic acid; an alicyclic dicarboxylic acid such as 1,4-cyclohexanedicarboxylic acid; ester-forming derivatives of these; and the like.

Among these, terephthalic acid in particular is preferred.

Furthermore, the hydroxycarboxylic acid as a compound component of the same polyester resin would be at least one of lactic acid, hydroxybutyric acid, polycaprolactone, and the like.

In addition, it is also preferable to use a non-crystalline polyester resin as a portion or the entirety of the polyester resin.

For example, a non-crystalline polyester resin formed from dicarboxylic acids composed of at least 80 mol % of terephthalic acid, and diols composed of 50 mol % to 80 mol % of ethylene glycol and 20 mol % to 50 mol % of one or more diols selected from 1,4-cyclohexanedimethanol, neopentyl glycol, and diethylene glycol, can be suitably used. If necessary, other dicarboxylic acids and diols, or hydroxycarboxylic acids would also be used in order to change the property of the film. Furthermore, they would be used singly or as mixtures.

On the other hand, examples of the crystalline polyester resin include polyethylene terephthalate, polyethylene naphthalate, polybutylene terephthalate, polybutylene naphthalate, and polypropylene terephthalate; however, they would be used singly or as a mixture.

Furthermore, when the polyester resin is a mixture of a non-crystalline polyester resin and a crystalline polyester resin, it is also preferable to blend the resin constituting the heat-shrinkable polyester film with a predetermined amount of a non-crystalline polyester resin in order to obtain satisfactory heat resistance, shrinkage ratio, and the like.

That is, it is preferable that the blending amount of the non-crystalline polyester resin usually has a value within the range of 70% to 100% by weight, more preferably a value within the range of 80% to 98% by weight, and even more preferably a value within the range of 85% to 95% by weight, with respect to the total amount (100% by weight) of the resin constituting the heat-shrinkable polyester film.

### 2. Heat Shrinkage Ratio Measured Using Motion Capture

### (1) Basic Configuration

The heat shrinkage ratio in the main shrinkage direction obtained using a motion capture device is usually configured to be obtained by measuring at least two measurement positions in the TD direction, which is the main shrinkage direction of the heat-shrinkable polyester film as an object to be measured, before and after heat shrinkage by using inertial sensors or an optical technique, and calculating the heat shrinkage ratio from the distance traveled.

That is, the change in the interval between two measurement positions is measured by utilizing a motion capture device and corresponding inertial sensors, infrared rays, or the like, and the heat shrinkage ratio is calculated.

More specifically, it is configured that the interval of two measurement positions is designated as L1, the distance of the predetermined interval after heat shrinkage is measured using a motion capture device at a predetermined heat shrinkage temperature for a predetermined heat shrinkage time as predetermined heat shrinkage conditions, and the heat shrinkage ratio is calculated based on the above-mentioned Formula (1) by using the distance as L′1.

Then, the heat-shrinkable polyester film of the present invention has such a predetermined heat shrinkage ratio (temperature: 70° C. to 98° C., time: 1 to 60 seconds) of 20% or more.

The reason for this is that by having such a predetermined heat shrinkage ratio, the heat shrinkage characteristics of the heat-shrinkable polyester film can be managed quickly and precisely.

Therefore, it is preferable that the predetermined heat shrinkage ratio (temperature: 70° C. to 98° C., time: 1 to 60 seconds) has a value of 30% to below 95%, more preferably a value within the range of 40% to below 90%, and even more preferably a value of 50% to below 85%.

Furthermore, it is preferable that the value of the interval L1 (mm) between two measurement positions is appropriately selected according to the size of the heat-shrinkable polyester film, the type of the motion capture device, and the like; however, it is preferable that the interval L1 has, for example, a value within the range of 3 to 300 mm.

The reason for this is that, with such an interval, the difference in the interval before shrinkage and after shrinkage of the film can be clearly recognized, and the heat shrinkage ratio in the TD direction can be measured more quickly and accurately.

Therefore, it is more preferable that the interval L1 (mm) of the measurement positions has a value within the range of 5 to 100 mm, and more preferably a value within the range of 8 to 30 mm.

Furthermore, the measurement position is a portion indicating the positional information of coordinates provided on the heat-shrinkable polyester film in order to measure the behavior of the heat-shrinkable polyester film during heat shrinkage.

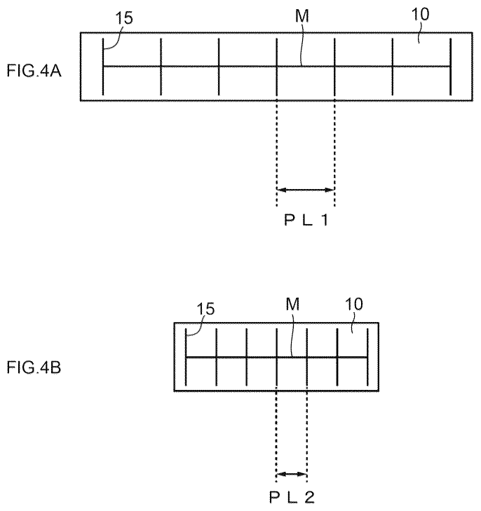

That is, as shown in FIGS. 4A and 4B, it is preferable that a predetermined marker 15 such as a dot, a line, a cross, a circle, an arrow, letter L, letter T, or a check mark is recorded as a predetermined section M between two measurement positions.

The reason for this is that, by adopting such a configuration, the state of the heat-shrinkable polyester film undergoing shrinkage can be easily recognized from the surroundings.

### (2) Variation in Thickness

Furthermore, it has been found that the heat shrinkage ratio in the TD direction measured using a motion capture device would be affected by the thickness of the heat-shrinkable polyester film.

Therefore, it is preferable that the thickness of the heat-shrinkable polyester film is within the range of 10 to 200 μm, and at the same time, the difference between the maximum value of the thickness and the average value of thickness (hereinafter, sometimes referred to as a variation in thickness) is 10 μm or less.

The reason for this is that, by controlling the thickness and the variation in thickness of such a heat-shrinkable polyester film, the heat shrinkage ratio in the TD direction is also easily controlled, and further, the heat shrinkage ratio in the TD direction can be controlled more quickly and precisely.

However, when such a variation in thickness becomes excessively small, the production yield is extremely lowered, and it would be economically disadvantageous.

Therefore, it is more preferable that the variation in thickness has a value within the range of 0.01 to 5 μm, and even more preferably a value within the range of 0.1 to 3 μm.

Incidentally, the thickness of the heat-shrinkable polyester film usually has a value within the range of 10 to 200 μm; however, it is more preferable that the thickness has a value within the range of 20 to 100 μm, and even more preferably a value within the range of 30 to 60 μm.

Furthermore, regarding the variation in thickness of the heat-shrinkable polyester film, it is preferable that a plurality of different locations (for example, n=3 to 30 locations) on the same film are selected, and the variation in thickness is calculated based on the maximum value and the average value of the measured thicknesses.

The reason for this is that, by calculating the thickness in this way, evaluation of the film can be carried out more quickly and accurately.

Therefore, it is more preferable to select 4 to 20 different locations of measurement positions on the same film, and it is even more preferable to select 5 to 10 locations of measurement positions.

### (3) Heat Shrinkage Ratios at Plurality of Locations

Furthermore, it is preferable that the interval between two measurement positions is set at a plurality of sites, the heat shrinkage in the TD direction at the plurality of sites is calculated, and the average value thereof is designated as the heat shrinkage ratio in the TD direction.

That is, it is preferable to select a plurality of different locations (for example, n=3 to 30 locations) on the same film, and take the average value of the measured heat shrinkage ratios (temperature: 70° C. to 98° C., time: 1 to 60 seconds) as the heat shrinkage ratio in the TD direction.

The reason for this is that, by calculating the heat shrinkage in the TD direction at a plurality of sites, the heat shrinkage ratio in the TD direction can be measured more quickly and accurately.

Therefore, it is more preferable to select at least 4 to 20 locations of measurement positions, and even more preferably 5 to 10 locations of measurement positions, in the TD direction of the heat-shrinkable polyester film.

### (4) Standard Deviation of Heat Shrinkage Ratio in TD Direction (σ1)

Furthermore, it is preferable that, when the heat-shrinkable polyester film is caused to undergo heat shrinkage under the conditions of a predetermined temperature and a predetermined time, it is preferable that the standard deviation for the heat shrinkage ratio in the TD direction is 15% or less.

The reason for this is that, by setting such a standard deviation, the heat shrinkage ratio of the heat-shrinkable polyester film can be controlled more precisely.

Therefore, it is more preferable that the standard deviation for the heat shrinkage ratio in the TD direction has a value of 10% or less, and even more preferably a value of 5% or less.

### (5) Motion Capture Device

### 1) Basic Configuration

It is preferable that the interval between the measurement positions in the heat-shrinkable polyester film is calculated based on the positional information of the measurement positions obtained by a motion capture device.

The reason for this is that, by using such a motion capture device, the interval between the measurement positions on the film can be acquired quickly and accurately as digital data.

Here, motion capture is a technology for converting the movement of a measurement target into digital data, and is mainly a technology for tracking the position of a predetermined marker that serves as a measurement target and recording the position as coordinate data.

Specifically, the type of the motion capture device is not particularly limited; however, there are image-type motion capture devices, inertial motion capture devices, optical motion capture devices, and motion capture devices as combinations of these, among which any type of motion capture device can be used.

However, in the case of the heat-shrinkable polyester film, since the film is subjected to heating through hot water immersion or the like, under a condition that there are many spatial limitations, in view of being easily adopted as a miniaturized or simplified device, it can be said to be more preferable to use an image-type or inertial motion capture device.

Therefore, as shown in FIG. 2A, it is preferable that the heat shrinkage ratio is measured using an optical camera as an image-type motion capture device 14, capturing a video image during heat shrinkage of the heat-shrinkable polyester film 10 as an object to be measured, and performing image analysis on the acquired data.

That is, it is preferably configured that a plurality of graduations (for example, 2 to 30 marks) are provided in advance at intervals of L1 on the heat-shrinkable polyester film using a predetermined marker such as an oil marker.

Next, it is preferably configured that the heat-shrinkable polyester film is placed on a flat surface, and video images before and after heat shrinkage are captured from vertically above using an optical camera.

In addition, it is preferably configured that the intervals between graduation marks before heat shrinkage are each calculated from the data of the captured video images from the relation between the pixel count and the actual measurement data, and the average value of the intervals is defined as the heat shrinkage ratio.

Specifically, for example, in an embodiment in which graduation marks are lined up on the left and right sides, it is preferable that a horizontal imaginary line is drawn so as to intersect with each graduation mark, and the point at which a graduation mark and the imaginary line intersect with each other is defined as the measurement position.

The reason for this is that, by continuously recording the state of heat shrinkage as video image data, the heat shrinkage ratio in the TD direction can be measured more quickly, more accurately, and more efficiently.

It is because, by recording in this way, even in a case where there are many spatial limitations, the device can be further miniaturized and simplified, and the heat shrinkage ratio can be measured more efficiently.

Incidentally, the type of the predetermined marker would be any form that is easily recognized by an optical camera; however, it is preferably configured that the predetermined marker is, for example, an oil marker or a groove.

Furthermore, it is preferable that the motion capture device is configured as an inertial position measuring device that can obtain information on acceleration, angular velocity, and orientation obtained from inertial sensors attached to the heat-shrinkable polyester film using a device such as IMU, and accurately specify the position of a marker (center of gravity or the like).

That is, it is preferable that the motion capture device is an inertial motion capture device equipped with 9-axis inertial sensors that combine an accelerometer and an angular velocity meter (gyro sensor) and further combine these with a geomagnetometer.

On the other hand, it is also preferable to use an optical motion capture device as the motion capture device.

That is, it is preferable that the motion capture device is a kind of optical position measuring device of a type that irradiates radiation such as infrared rays from the motion capture device toward an optical marker (a retroreflective marker or the like) and detects the reflected light.

Such a motion capture device is a measuring device that can perform predetermined image processing based on the obtained reflected light and two-dimensionally identify the position (center of gravity or the like) of a marker, and is capable of three-dimensional position identification by using a plurality of motion capture devices in combination.

### 2) Use of Optical Camera

Furthermore, as shown in FIGS. 2B and 2C, it is preferable that images of the state of heat shrinkage of the heat-shrinkable polyester film 10 are captured as well by using predetermined optical cameras 14a and 14b in combination with an inertial motion capture device 14, and the images are used as image data to serve as a reference for measuring the heat shrinkage ratio.

The reason for this is that, by combining camera images and continuously recording the state of heat shrinkage in this way, the state of heat shrinkage in the TD direction can be checked as image data, and further, the heat shrinkage ratio in the TD direction can be measured more efficiently and more accurately.

More specifically, it is preferable that a single optical camera or a plurality of optical cameras are prepared, and image data of the state of heat shrinkage of the heat-shrinkable polyester film are captured from the front, side, top, back, or oblique directions of the heat-shrinkable polyester film as an object to be measured.

### 3) Heat Shrinkage Conditions

It is preferable that the temperature as a heat shrinkage condition has a value within the range of 70° C. to 98° C., and the time has a value within the range of 1 to 60 seconds.

The reason for this is that, by adopting such heat shrinkage conditions, the resulting heat shrinkage characteristics can be easily compared and verified with the heat shrinkage characteristics at the time of actually using the heat-shrinkable polyester film.

Therefore, as heat shrinkage conditions, from the viewpoint that the conditions are close to the actual heat shrinkage conditions and can be measured in a relatively short time, it is more preferable that the heat shrinkage temperature has a value within the range of 75° C. to 95° C., while the heat shrinkage time has a value within the range of 5 to 30 seconds, and it is even more preferable that the heat shrinkage temperature has a value within the range of 80° C. to 90° C., while the heat shrinkage time has a value within the range of 8 to 15 seconds.

In addition, it has been found that when the accuracy of the motion capture device is improved, the heat shrinkage time is within the range of 1 to 5 seconds, or within the range of 1 to 3 seconds, the heat shrinkage ratio of the heat-shrinkable polyester film can be measured accurately.

### 4) Heat Shrinking Device

It is preferable that the heat shrinking device is at least one of a constant-temperature bath (oven), a steam bath, a hot water bath, a hot air heater, a liquid bath of a fluorine-containing compound, a steam bath of a fluorine-containing compound, and an infrared ray irradiating apparatus.

The reason for this is that, when a motion capture device is used, these various heat shrinking devices can be used according to the use applications and the like of the heat-shrinkable polyester film, and further, the heat shrinkage ratio can be measured more quickly, more accurately, and more simply.

Furthermore, as an example, it is preferable that the heat shrinking device is a hot water bath.

The reason for this is that, by using such a heat shrinking device, it is easy to constantly maintain the temperature of hot water, and control of the heat shrinkage temperature can be carried out more precisely.

In addition, it is because, by using a hot water bath, the heat-shrinkable polyester film can be floated and heated planarly and uniformly, and the behavior of the heat-shrinkable polyester film at the time of heat shrinkage can be more easily captured from above using an optical camera or the like.

Specifically, when a single motion capture device is used, the heat shrinkage ratio can be measured from two-dimensional measurement points and calculated, whereas when a plurality of motion capture devices are used, there is an advantage that the positional relation of three-dimensional measurement points can be measured, and the heat shrinkage ratio can be measured and calculated.

For example, even when a flat plate-shaped hot plate is used as a heat shrinking device, and when the device is disposed not only in a horizontal direction but also in a vertical direction so as to be tilted along the direction of gravity or to be parallel to the direction of gravity, the heat shrinkage ratio can be easily and quickly measured three-dimensionally.

Therefore, when a single motion capture device or a plurality of motion capture devices are used, since various heat shrinkage devices can be used, measurement of the heat shrinkage ratio can be carried out more simply and more quickly depending on the use applications and the like of the heat-shrinkable polyester film.

In addition, as another example, it is preferable that a hot air heater is used as the heat shrinking device.

That is, it is preferable to use, as the hot air heater, a device in which air supplied by a compressed air pump, a fan, or the like is blown onto an object via a heat source such as an electric heating wire or an oil heater.

Specifically, for example, the heat shrinking device is preferably configured such that a heat-shrinkable polyester film planarly placed on a belt conveyor or a mounting table, is caused to undergo heat shrinkage by blowing hot air from vertically above the heat-shrinkable polyester film.

The reason for this is that, by using such a heat shrinking device, the degree of freedom for the place of disposition of the device is increased, the heat shrinking device can be disposed above a heat-shrinkable polyester film manufacturing apparatus, and the heat shrinkage rate can be measured more easily in-line by blowing hot air onto cut-off ends and the like.

Therefore, in the case of using a hot air heater in this way, from the viewpoint of effectively transferring the quantity of heat of the hot air to the heat-shrinkable polyester film, the heat-shrinkable polyester film is preferably configured to receive the hot air within a tunnel-shaped housing made of stainless steel, aluminum, glass, or the like.

### 5) Fixing Jig

Furthermore, as shown in FIGS. 2A to 2C, for example, it is preferable that a hot water bath 20 that holds hot water 22 maintained at a predetermined temperature by a heater 22a is prepared, and the heat-shrinkable polyester film is caused to undergo heat shrinkage in a main shrinkage direction by immersing the film in hot water under the conditions of a heat shrinkage temperature of 70° C. to 98° C. for a shrinkage time of 1 to 60 seconds.

At that time, as shown in FIGS. 2A and 2B, it is preferable that a mesh-shaped fixing jig 12 formed from stainless steel wires or the like is prepared, and the heat-shrinkable polyester film 10 is partially accommodated inside the fixing jig.

Furthermore, upon causing the heat-shrinkable polyester film to undergo heat shrinkage, it is preferable to use a frame-shaped fixing jig that maintains the position of the heat-shrinkable polyester film without interfering with the shrinkage of the heat-shrinkable polyester film.

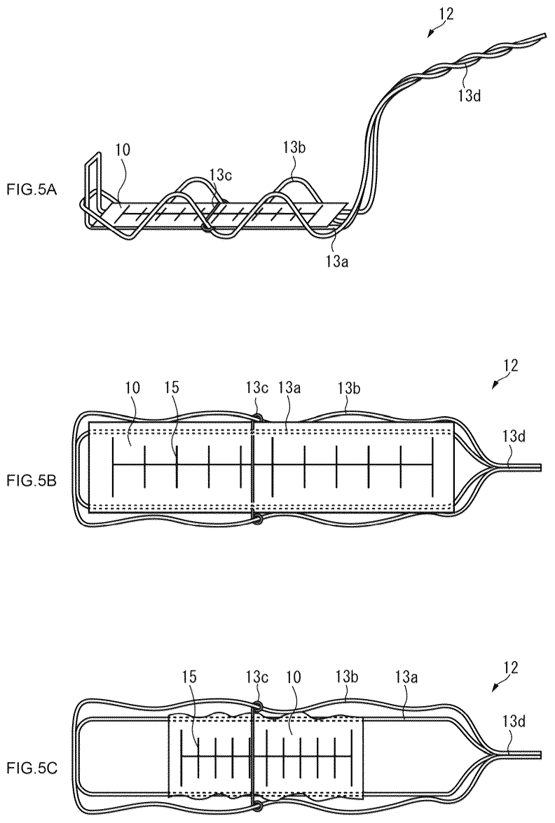

That is, as shown in FIGS. 5A to 5C as an example, it is preferable that the fixing jig 12 has a placement part 13a that is composed of a frame member and places and maintains at least a heat-shrinkable polyester film; a guide part 13b that controls the shrinkage direction of the heat-shrinkable polyester film; and a regulating part 13c that prevents misalignment during heat shrinkage.

In addition, from the viewpoint of further improving handleability, it is preferable that the fixing jig 12 is provided with at least a handle part 13d that is disposed at an end part in the main shrinkage direction of the placement part 13a and protrudes obliquely upward.

Specifically, it is preferable that the fixing jig is composed of a metal wire made of stainless steel, iron, aluminum, copper, or the like, or a frame member made of a resin or the like.

The reason for this is that, by configuring the fixing jig in this way, the heat-shrinkable polyester film can be stably placed, and at the same time, the heat shrinkage rate can be measured more accurately by reducing shake during heat shrinkage.

Furthermore, from the viewpoint of the ease of handling and uniform heating of the heat-shrinkable polyester film, it is preferable that the placement part is a substantially flat frame-shaped part and is two rail-shaped parts parallel to at least the main shrinkage direction when viewed in a plan view from vertically above.

Furthermore, it is preferable that the guide part is a part that is disposed parallel to the placement part when viewed in a plan view from vertically above, and curves in a wavy form up and down in the vertical direction.

In addition, the regulating part is a part disposed to bridge the guide part in a direction perpendicular to the main shrinkage direction and made movable up and down along the frame of the guide part, and is a part that clamps the heat-shrinkable polyester film placed on the placement part, between the placement part and the regulating part.

The reason for this is that, by configuring the guide part in this way, a positional shift of the heat-shrinkable polyester film can be prevented during heat shrinkage, and at the same time, the center position of shrinkage can be stabilized so as to accurately measure the heat shrinkage rate using a motion capture device.

Then, by curving the guide part into a wavy form, for example, when a hot water bath is used as the heat shrinking device during heat shrinkage, the heat-shrinkable polyester film can be landed on water without creating waves, and by adjusting the height of the guide part to match the water level, measurements can be made with the guide part placed at the bottom of the water bath.

### 6) Heat Shrinkage Ratio in MD Direction

It is preferable that the heat shrinkage ratio (B1) in a direction orthogonally intersecting the main shrinkage direction of the heat-shrinkable polyester film as an object to be measured is measured as the heat shrinkage ratio in the MD direction using a motion capture device at the same time as the measurement of the heat shrinkage ratio in the TD direction.

By simultaneously measuring the heat shrinkage ratio in the MD direction using a motion capture device in this way, the heat shrinkage characteristics can be compared with the heat shrinkage characteristics at the time of actually using the heat-shrinkable polyester film, according to the use applications and the like of the heat-shrinkable polyester film.

Incidentally, it is preferable that such a heat shrinkage ratio in the MD direction has a value within the range of −5% to 5%.

### 7) Calibration Curve

It is preferable that a calibration curve showing the relation between the heat shrinkage temperature and heat shrinkage time in the main shrinkage direction of the heat-shrinkable polyester film as an object to be measured, and the heat shrinkage ratio in the TD direction obtained using a motion capture device, is prepared in advance, and the calibration curve and the heat shrinkage ratio obtained based on Formula (1) are compared and verified.

By comparing the heat shrinkage ratio with a calibration curve prepared in advance in this way, a heat-shrinkable polyester film having a heat shrinkage ratio that is excellently reproducible can be obtained more quickly and more precisely.

### 3. Thermal Characteristics and the Like of Heat-Shrinkable Polyester Film

### (1) Configuration (a)

As configuration (a), the heat-shrinkable polyester film as an object to be measured preferably has a configuration requirement to the effect that, in the heat-shrinkable polyester film of the first embodiment, a heat shrinkage ratio A1 in a case where the main shrinkage direction is defined as TD direction, and the film is caused to shrink in the TD direction under the conditions of a temperature of 95° C. for 1 second, has a value of 30% to below 95%.

The reason for this is that, by limiting such 95° C. heat shrinkage ratio A1 to be 30% to below 95%, a satisfactory heat shrinkage ratio is obtained for the heat-shrinkable polyester film during heat shrinkage, and further, the maximum shrinkage stress is also easily obtained.

Therefore, as the configuration (a), it is more preferable that the 95° C. heat shrinkage ratio A1 has a value within the range of 40% to below 90%, and even more preferably a value within the range of 50% to below 85%.

Furthermore, as configuration (a′), the heat-shrinkable polyester film as an object to be measured preferably has a configuration requirement to the effect that a heat shrinkage ratio A′1 in a case where the main shrinkage direction is defined as TD direction, and the film is caused to shrink in the TD direction under the conditions of a temperature of 95° C. for 10 seconds, has a value within the range of 60% to below 95%.

The reason for this is that, by limiting such 95° C. heat shrinkage ratio A′1 to be 60% to below 95%, a satisfactory heat shrinkage ratio is obtained for the heat-shrinkable polyester film during heat shrinkage, and further, the maximum shrinkage stress is also easily obtained.

Therefore, as the configuration (a′), it is more preferable that the 95° C. heat shrinkage ratio A′1 has a value within the range of 65% to below 90%, and even more preferably a value within the range of 70% to below 85%.

Furthermore, with regard to the heat-shrinkable polyester film as an object to be measured, as configuration (a2), it is preferable that a heat shrinkage ratio A2 in a case where the main shrinkage direction is defined as TD direction, and the film is caused to shrink in the TD direction under the conditions of a temperature of 80° C. for 1 second, has a value within the range of 10% to below 80%.

The reason for this is that, by adjusting such 80° C. heat shrinkage ratio A2 to be within a predetermined range, a more satisfactory heat shrinkage ratio is obtained for the heat-shrinkable polyester film during heat shrinkage, and further, the maximum shrinkage stress is also easily obtained.

Therefore, as the configuration (a2), it is more preferable that the 80° C. heat shrinkage ratio A2 has a value within the range of 15% to below 70%, and even more preferably a value within the range of 20% to below 50%.

Furthermore, with regard to the heat-shrinkable polyester film as an object to be measured, as configuration (a′2), it is preferable that a heat shrinkage ratio A′2 in a case where the main shrinkage direction is defined as TD direction, and the film is caused to shrink in the TD direction under the conditions of a temperature of 80° C. for 10 seconds, has a value within the range of 10% to below 85%.

The reason for this is that, by adjusting such 80° C. heat shrinkage ratio A′2 to be within a predetermined range, a more satisfactory heat shrinkage ratio is obtained, and further, the maximum shrinkage stress is also easily obtained.

Therefore, as the configuration (a′2), it is more preferable that the 80° C. heat shrinkage ratio A′2 has a value within the range of 20% to below 75%, and even more preferably a value within the range of 30% to 65%.

### (2) Configuration (b)

Furthermore, as configuration (b), it is preferable that the heat-shrinkable polyester film has a configuration requirement to the effect that the maximum shrinkage stress at a shrinkage temperature 95° C. in the TD direction of the heat-shrinkable polyester film is designated as B, and this B has a value within the range of 2 to 10 MPa.

The reason for this is that, by specifically limiting B to a value within a predetermined range in this way, wrinkles that would occur due to excess and deficiency of the maximum shrinkage stress can be suppressed.

Therefore, as the configuration (b), it is more preferable that the maximum shrinkage stress B at a shrinkage temperature of 95° C. has a value within the range of 2.5 to 9.5 MPa, and even more preferably a value within the range of 3 to 9 MPa.

### (3) Configuration (c)

Furthermore, as configuration (c), it is preferable that the heat-shrinkable polyester film has a configuration requirement to the effect that a numerical value expressed by B/A1 based on the maximum shrinkage stress B and the heat shrinkage ratio A1, has a value within the range of 0.08 to 0.15 MPa/%.

The reason for this is that, by specifically limiting B/A1 to a value within a predetermined range in this way, even in a case where the values of the configuration (a) and the configuration (b) fluctuate to some extent, the causes of predetermined influencing factors can be reduced, uneven shrinkage caused by sudden thermal response in the heat-shrinkable polyester film during heat shrinkage can be suppressed, and as a result, the occurrence of fine wrinkles can also be suppressed.

### (4) Configuration (d)

Furthermore, as configuration (d), it is preferable that the heat-shrinkable polyester film has a configuration requirement to the effect that a numerical value expressed by B/t, which is a ratio between the maximum shrinkage stress B in the heat-shrinkable polyester film and the thickness t (μm) thereof, has a value within the range of 0.05 to 0.4 MPa/m.

The reason for this is that, by specifically limiting B/t to a value within a predetermined range in this way, the numerical value represented by B/A1 is more easily controlled to a value with a predetermined range.

Therefore, by reducing the causes of predetermined influencing factors, uneven shrinkage caused by sudden thermal response in the heat-shrinkable polyester film during heat shrinkage can be suppressed, and as a result, the occurrence of fine wrinkles can also be effectively suppressed.

### (5) Configuration (e)

Furthermore, as configuration (e), it is preferable that the heat-shrinkable polyester film has a configuration requirement related to a stretch ratio in the MD direction (average stretch ratio in MD direction, sometimes simply referred to as MD direction stretch ratio) of the heat-shrinkable polyester film before shrinkage.

Further, it is a suitable embodiment that the MD direction stretch ratio has a value within the range of 100% to 200%.

The reason for this is that, by specifically limiting the MD direction stretch ratio to a value within a predetermined range in this way, and specifically limiting predetermined heat shrinkage ratios and the like each to a value within a predetermined range, the occurrence of fine wrinkles can be further suppressed.

Therefore, as the configuration (e), it is more preferable that the MD direction stretch ratio to a value within the range of 105% to 180%, and even more preferably a value within the range of 110% to 160%.

### (6) Configuration (f)

Furthermore, as configuration (f), it is preferable that the heat-shrinkable polyester film has a configuration requirement related to a stretch ratio in the TD direction (average TD direction stretch ratio, sometimes simply referred to as TD direction stretch ratio) of the heat-shrinkable polyester film before heat shrinkage.

It is preferable that such TD direction stretch ratio has a value within the range of 300% to 700%, more preferably a value within the range of 350% to 600%, and even more preferably a value within the range of 400% to 550%.

The reason for this is that, by specifically limiting the stretch ratio in the TD direction to a value within a predetermined range in this way, and specifically limiting predetermined thermal shrinkages and the like each to a value within a predetermined range, the occurrence of fine wrinkles can be further suppressed.

### (7) Configuration (g)

Furthermore, as configuration (g), it is preferable that the heat-shrinkable polyester film has a configuration requirement to the effect that the haze value of the heat-shrinkable polyester film before heat shrinkage, which is measured according to JIS K 7105, has a value of 7% or less.

The reason for this is that, by specifically limiting the haze value to a value within a predetermined range in this way, transparency of the heat-shrinkable polyester film is also easily controlled quantitatively, and since transparency is satisfactory, general-purpose usability can be further enhanced.

More specifically, it is because when the haze value of the film before heat shrinkage has a value of above 78, transparency would decrease, and it would be difficult to apply the film to decorative applications and the like for PET bottles.

On the other hand, it is because when the haze value of the film before heat shrinkage becomes excessively small, it would be difficult to control the haze value in a stable manner, and the production yield would decrease significantly.

Therefore, as the configuration (g), it is more preferable that the haze value of the film before heat shrinkage has a value within the range of 0.1% to 5%, and even more preferably a value within the range of 0.5% to 3%.

### (8) Configuration (h)

Furthermore, configuration (h) is a configuration requirement to the effect that the heat-shrinkable polyester film contains a non-crystalline polyester resin in an amount within the range of 90% to 100% by weight of the total amount.

The reason for this is that, by specifically limiting the content of the non-crystalline polyester resin in this way, the heat shrinkage ratio near the shrinkage temperature and the maximum shrinkage stress can be more easily adjusted to desired ranges, and at the same time, the haze value and the like are easily controlled quantitatively.

More specifically, it is because when the content of the non-crystalline polyester resin has a value of below 90% by weight, it would be difficult to control the shrinkage ratio near the shrinkage temperature of the heat-shrinkable polyester film and the maximum shrinkage stress.

Furthermore, when the content of the crystalline polyester resin becomes excessively large, there is a possibility that the range in which the causes of predetermined influencing factors are reduced would become markedly narrow.

Therefore, as the configuration (h), it is more preferable that the content of the non-crystalline polyester resin has a value within the range of 91% to 100% by weight of the total amount, and even more preferably a value within the range of 92% to 100% by weight of the total amount.

### 4. Configuration of Heat-Shrinkable Polyester Film

It is preferable that various additives are blended into the heat-shrinkable polyester film, or those additives are attached onto one surface or both surfaces of the film.

More specifically, it is preferable that at least one of a hydrolysis preventing agent, an antistatic agent, an ultraviolet absorber, an infrared absorber, a colorant, an organic filler, an inorganic filler, an organic fiber, an inorganic fiber, and the like is blended usually in an amount within the range of 0.01% to 10% by weight, and more preferably within the range of 0.1% to 1% by weight, with respect to the total amount of the heat-shrinkable polyester film.

Furthermore, as shown in FIG. 1B, it is also preferable that other resin layers 10a and 10b each containing at least one of these various additives are laminated on one surface or both surfaces of the heat-shrinkable polyester film 10.

In that case, it is preferable that when the thickness of the heat-shrinkable polyester film is taken as 100%, the single layer thickness or the total thickness of the other resin layers that are additionally laminated usually has a value within the range of 0.1% to 10%.

Then, the resin as a main component constituting the other resin layers may be the same polyester resin as that of the heat-shrinkable polyester film, or the resin is preferably at least one of an acrylic resin different from the polyester resin, an olefin resin, a urethane resin, a rubber resin, and the like.

Furthermore, it is also preferable that the heat-shrinkable polyester film is made to have a multilayer structure to further promote a hydrolysis preventive effect and mechanical protection, or as shown in FIG. 1C, a shrinkage ratio adjusting layer 10c is provided on the surface of the heat-shrinkable polyester film 10 so that the shrinkage ratio of the heat-shrinkable polyester film becomes uniform within the plane.

Such a shrinkage ratio adjusting layer can be laminated using an adhesive, a coating method, a heating treatment, or the like, depending on the shrinkage characteristics of the heat-shrinkable polyester film.

More specifically, the thickness of the shrinkage ratio adjusting layer is within the range of 0.1 to 3 μm, and when the shrinkage ratio of the heat-shrinkable polyester film at a predetermined temperature is excessively large, it is preferable to laminate a shrinkage ratio adjusting layer of a type that decreases the shrinkage ratio.

Furthermore, when the shrinkage ratio of the heat-shrinkable polyester film at a predetermined temperature is excessively small, it is preferable to laminate a shrinkage ratio adjusting layer of a type that increases the shrinkage ratio.

Therefore, it is intended to obtain a desired shrinkage ratio by using a shrinkage ratio adjusting layer, without producing various heat-shrinkable films having different shrinkage ratios as the heat-shrinkable polyester film.

### 5. Measurement of Other Thermal Characteristics

### (1) Heat Shrinkage Rate

Furthermore, when the heat-shrinkable polyester film is caused to undergo heat shrinkage along the main shrinkage direction at a predetermined temperature T for a predetermined time t1, it is preferable that the maximum value of the heat shrinkage rate calculated based on Formula (2) by utilizing a predetermined correlation between the distance information of a predetermined section and the measurement time obtained using a motion capture device, is adjusted to a predetermined range.

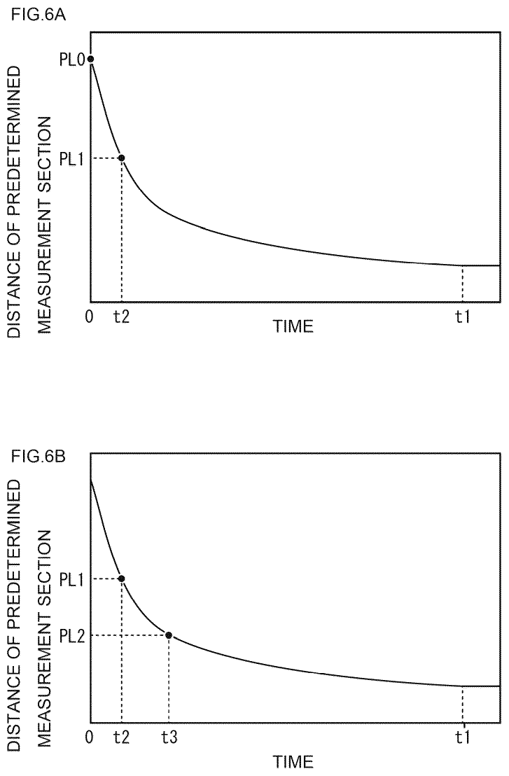

That is, as shown in FIG. 6A, it is preferable that the distance of a predetermined section measured using a motion capture device before heat shrinkage is PL0, the distance of a predetermined section measured using a motion capture device at a predetermined time t2, which is shorter than the predetermined time t1, is PL1, and the maximum value of the heat shrinkage rate that can be calculated based on Formula (2) is 3 mm/sec or more.

$$Heat shrinkage rate ( mm / sec ) = ( PL 0 - PL 1 ) / t 2 \qquad ( 2 )$$

PL0−PL1: distance change of predetermined section (mm)
t2: measurement time (seconds)

The reason for this is that, by taking the maximum value of such a heat shrinkage rate, the balance between the amount of change at which the heat-shrinkable polyester film changes most significantly and the time can be adjusted precisely, and the occurrence of wrinkles and the like in a case where the heat-shrinkable polyester film is used on an object can be effectively prevented.

Therefore, it is more preferable that the maximum value of the heat shrinkage rate is 3.5 mm/sec or more, and even more preferably 4 mm/sec or more.

Incidentally, it is preferable that the distance PL0 of a predetermined section before heat shrinkage is the same distance as L1 or the like.

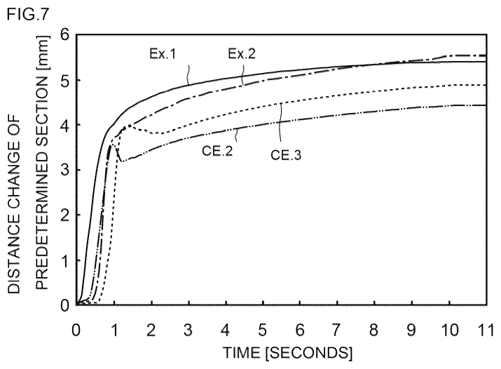

Here, referring to FIG. 7, the relation between time (seconds) and the distance change (mm) of a predetermined section will be described.

That is, for Examples 1 and 2 and Comparative Examples 2 and 3 that will be described below, the time (seconds) was plotted on the axis of abscissa, the maximum value of the distance change (mm) of predetermined sections provided at six locations at a distance of 10 mm along the main shrinkage direction was plotted on the axis of ordinate, and measurements were made at intervals of 0.1 seconds and graphed.

According to such a graph, it can be seen that in Example 1 and Example 2, the value increases uniformly between 0 seconds and 2 seconds, and even thereafter, continues to increase slowly.

It can be seen that in Comparative Example 2, there is a portion between 0 seconds to 1 second, in which the distance change of the predetermined section decreases.

On the other hand, it can be seen that in Comparative Example 3, the distance change of the predetermined section increases gently between 0 seconds to 1 second, rises sharply between 1 second to 2 seconds, and then decreases slightly.

In addition, it can be seen that in Comparative Example 3, at the time point after a lapse of one second from the start of heat shrinkage, the curve is about ⅓ to ½ of other relation curves.

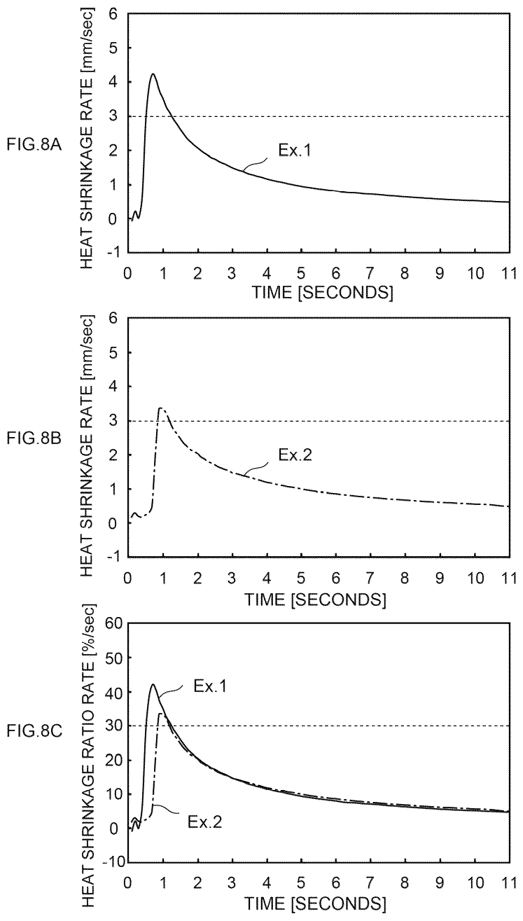

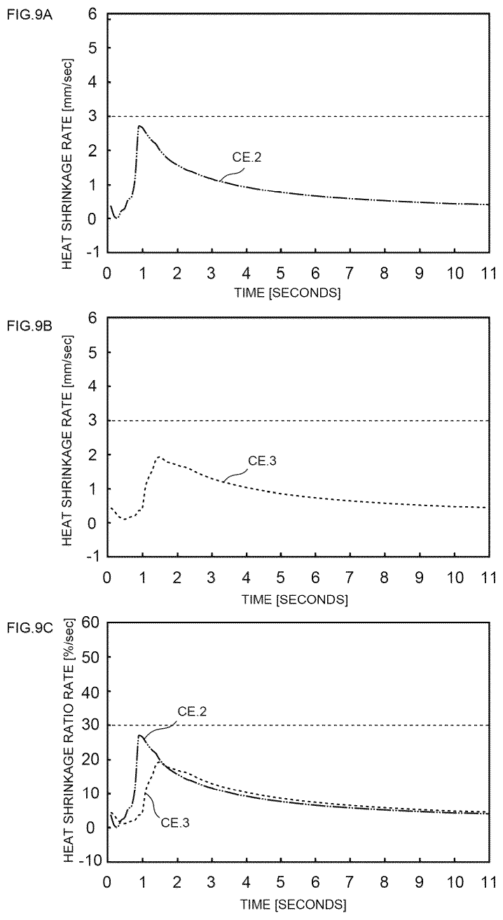

Furthermore, referring to FIGS. 8A and 8B and FIGS. 9A and 9B, the relation between the time (seconds) and the heat shrinkage rate (mm/sec) and heat shrinkage ratio rate (%/sec) will be described.

Specifically, for Examples 1 and 2 and Comparative Examples 1 and 2 that will be described below, the time (seconds) was plotted on the axis of abscissa, the heat shrinkage rate (mm/sec) with the smallest maximum value among predetermined sections provided at six locations at intervals of 10 mm along the main shrinkage direction was plotted on the axis of ordinate, and measurements were made at intervals of 0.1 seconds and graphed.

According to FIGS. 8A and 8B, it can be seen that in Example 1 and Example 2, the heat shrinkage rate increases in a relatively stable manner immediately after the start of heat shrinkage, exceeds 3 mm/sec after a lapse of about 1 second, and decreases to 3 mm/sec or less between 1 second and 2 seconds.

On the other hand, according to FIGS. 9A and 9B, it can be seen that in Comparative Example 2 and Comparative Example 3, the heat shrinkage rate does not increase that much immediately after the start of heat shrinkage, and does not exceed 3 mm/sec even after a lapse of 1 second from the start point of heat shrinkage.

Incidentally, in the case of FIG. 8C and FIG. 9C, a heat shrinkage rate of 1 mm/sec corresponds to a heat shrinkage ratio rate of 10%/sec.

### (2) Heat Shrinkage Ratio Rate

Furthermore, with regard to the heat-shrinkable polyester film, as shown in FIG. 6A, it is preferable that the maximum value of the heat shrinkage ratio rate in the main shrinkage direction calculated based on the following Formula (3) is 30%/sec or more.

$$Heat shrinkage ratio rate ( \% / sec ) = ( PL 0 - PL 1 ) / ( PL 0 \times t 2 ) \times 100 \qquad ( 3 )$$

The reason for this is that, by taking such a heat shrinkage ratio rate, the balance between the amount of change at which the heat-shrinkable polyester film changes most significantly and the time can be adjusted precisely, and the occurrence of wrinkles and the like in a case where the heat-shrinkable polyester film is used on an object can be effectively prevented.

In addition, it is because, by measuring the amount of change related to the heat shrinkage ratio, evaluation of the heat-shrinkable polyester film can be carried out without depending on the distance of the predetermined section.

Therefore, it is more preferable that the maximum value of the heat shrinkage ratio rate is 3.5%/sec or more, and even more preferably 4%/sec or more.

### (3) Standard Deviation of Maximum Value of Heat Shrinkage Rate

Furthermore, regarding the heat-shrinkable polyester film, it is preferable that when a plurality of predetermined sections are provided, and the heat shrinkage rate for each of the predetermined sections from the start point of heat shrinkage to a predetermined time t1 is determined at every 0.1 seconds, the standard deviation of the maximum value of the heat shrinkage rate for each predetermined section is 3.5 mm/sec or less.

The reason for this is that, by taking such a standard deviation, the shrinkage ratio per hour during heat shrinkage can be adjusted precisely, and the behavior during heat shrinkage is further stabilized.

Therefore, it is more preferable that the standard deviation of the maximum value of the heat shrinkage rate is 1 mm/sec or less, and even more preferably 0.3 mm/sec or less.

Incidentally, the standard deviation is the square root of the sum of the squares of deviations divided by the value of (number of data points−1).

### (4) Heat Shrinkage Rate in Predetermined Period (Intermediate Heat Shrinkage Rate)

Furthermore, with regard to the heat-shrinkable polyester film, as shown in FIG. 6B, when a predetermined section is provided along the main shrinkage direction of the heat-shrinkable polyester film in a state of being capable of shrinking in at least one of the longitudinal direction or the width direction, and the film is caused to undergo heat shrinkage at a predetermined temperature T for a predetermined time t1, it is preferable that the heat shrinkage rate in the main shrinkage direction in a predetermined time period (hereinafter, sometimes referred to as intermediate heat shrinkage rate) is 20 mm/sec or less, as calculated based on the following Formula (4) from the distance change between a distance PL0 of the predetermined section before heat shrinkage, a distance PL1 of the predetermined section at a predetermined time t2, which is shorter than the predetermined time t1, and a distance PL2 of the predetermined section at a predetermined time t3, which is shorter than the predetermined time t1 and longer than the predetermined time t2.

$$Intermediate heat shrinkage rate ( mm / sec ) = ( PL 1 - PL 2 ) / ( t 3 - t 2 ) \qquad ( 4 )$$

PL1−PL2: distance change of predetermined section (mm)
t3−t2: measurement period (seconds)

The reason for this is that, by adopting such an intermediate heat shrinkage rate, a predetermined correlation between the distance change of a predetermined section of the heat-shrinkable polyester film during heat shrinkage and the positional information obtained by a motion capture device or the like, can be utilized. In addition, it is because the heat shrinkage rate of the heat-shrinkable polyester film can be adjusted to a value within a predetermined range, and excellent heat shrinking property can be stably exhibited.

Therefore, it is more preferable that the heat shrinkage rate in the measurement period is 18 mm/sec or less, and even more preferably 15 mm/sec or less.

Incidentally, the intermediate heat shrinkage rate is defined to have a positive value in the shrinkage direction of the heat-shrinkable polyester film, and is defined to have a negative value in a case where the heat-shrinkable polyester film elongates in reaction to shrinkage, or in a case where the film is three-dimensionally distorted due to rapid heat shrinkage and thereafter returns to a planar shape, or the like.

Furthermore, for the heat-shrinkable polyester film, it is preferable that the measurement period t3−t2 has a value of 3 seconds or less.

The reason for this is that, by adopting such a measurement period, the behavior during heat shrinkage can be measured more accurately.

Therefore, it is more preferable that the measurement period t3−t2 has a value of 2 seconds or less, and even more preferably a value of 1 second or less.

On the other hand, from the viewpoint of preventing an increase in measurement errors and the like caused by excessively increasing the time resolution, it is preferable that the measurement period t3−t2 has a value of 0.1 seconds or more.

Furthermore, it is preferable that the intermediate heat shrinkage rate always has a positive value during heat shrinkage; however, it has been found that even in a case where the intermediate heat shrinkage rate has a negative value, there is no problem with the intended use of the heat-shrinkable polyester film so long as the value is small.

Therefore, with regard to the heat-shrinkable polyester film, it is preferable that the minimum value of the intermediate heat shrinkage rate during that predetermined period is suppressed to be −2.5 mm/sec or more.

It is because, by suppressing the behavior of the heat-shrinkable polyester film such that the intermediate heat shrinkage rate has a negative value in this way, wrinkles and the like in the case of using the film as a heat-shrinkable polyester film can be prevented more effectively.

Therefore, it is more preferable that the minimum value of the intermediate heat shrinkage rate is −1.5 mm/sec or more, and even more preferably 0 mm/sec or more.

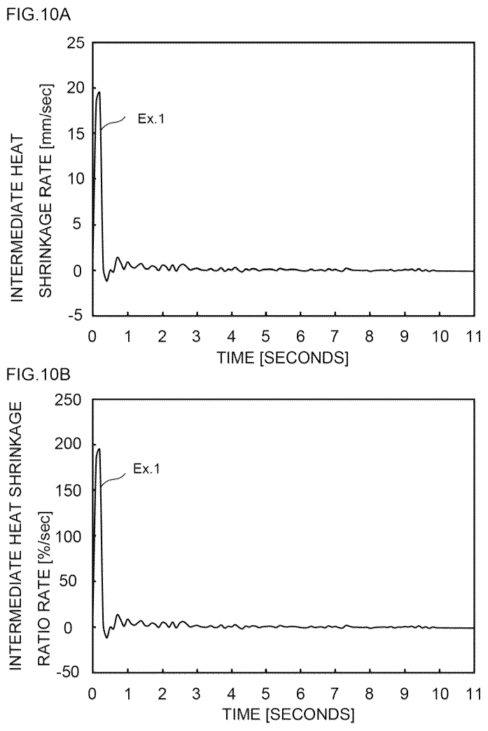

Here, referring to FIG. 10A to FIG. 13A, the relation between the time (seconds) and the intermediate heat shrinkage rate (mm/sec) will be described.

Specifically, regarding Examples 1 and 2 and Comparative Examples 2 and 3 that will be described below, the time (seconds) was plotted on the axis of abscissa, the maximum value of the intermediate heat shrinkage rate (mm/sec) of predetermined sections provided at six locations at intervals of 10 mm along the main shrinkage direction was plotted on the axis of ordinate, and measurements were made at intervals of 0.1 seconds and graphed.

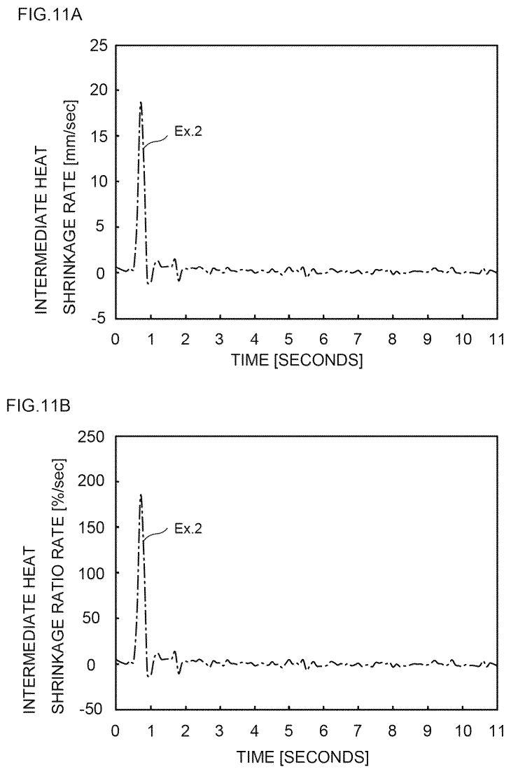

According to such FIG. 10A to FIG. 11A, it can be seen that in Example 1 and Example 2, the intermediate heat shrinkage rate reaches the maximum value between 0 seconds and 1 second, and decreases to about 0 mm/sec after a lapse of 1 second from the start point of heat shrinkage.

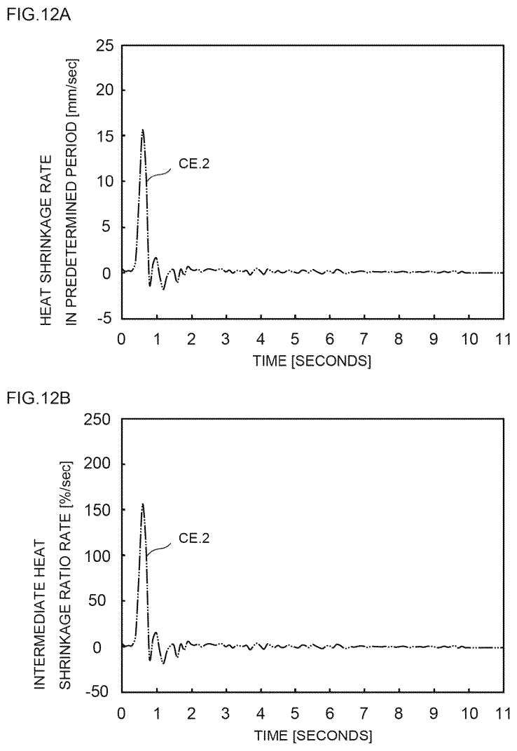

On the other hand, according to FIG. 12A, it can be seen that in Comparative Example 2, the intermediate heat shrinkage rate reaches the maximum value between 0 seconds and 1 second, but between 1 second and 2 seconds thereafter, the intermediate heat shrinkage rate varies greatly with 0 mm/sec as a limit.

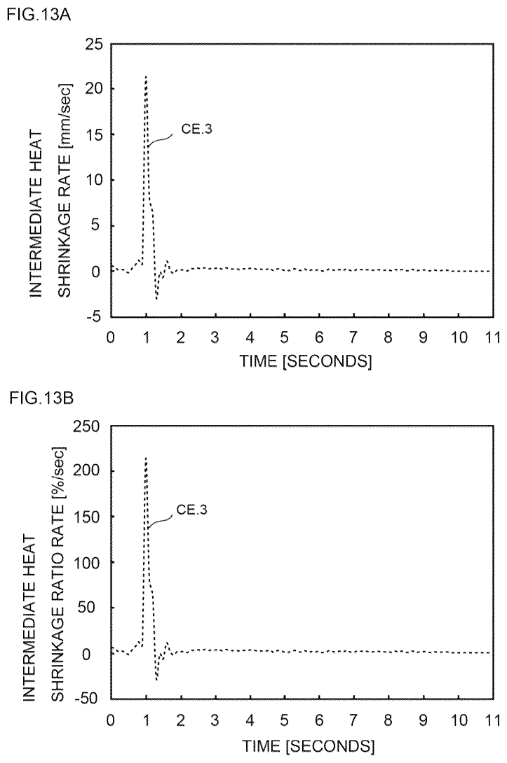

In addition, according to FIG. 13A, it can be seen that in Comparative Example 3, the intermediate heat shrinkage rate is 5 mm/sec or less between 0 seconds and 1 second, increases to above 20 mm/sec after a lapse of about 1 second, and thereafter decreases to 5 mm/sec or less between 1.1 seconds and 1.5 seconds.

Incidentally, in the case of FIG. 10B to FIG. 13B, a heat shrinkage rate of 1 mm/sec corresponds to a heat shrinkage ratio rate of 10%/sec.

### (5) Standard Deviation of Maximum Value of Intermediate Heat Shrinkage Rate

Furthermore, with regard to the heat-shrinkable polyester film, when a plurality of predetermined sections are provided, and the intermediate heat shrinkage rate for each of the predetermined sections from the start point of heat shrinkage to a predetermined time t1 is determined at every 0.1 seconds, it is preferable that the standard deviation of the maximum value of the intermediate heat shrinkage rate for each predetermined section is 4.5 mm/sec or less.

The reason for this is that, by adopting such a standard deviation, the shrinkage ratio within a predetermined time during heat shrinkage can be adjusted precisely, and the behavior during heat shrinkage is further stabilized.

Therefore, it is more preferable that the standard deviation of the maximum value of the intermediate heat shrinkage rate is 3.5 mm/sec or less, and even more preferably 3 mm/sec or less.

Incidentally, the standard deviation is the square root of the sum of the squares of deviations divided by the value of (number of data points−1).

### (6) Heat Shrinkage Ratio Rate in Predetermined Period (Intermediate Heat Shrinkage Ratio Rate)

Furthermore, when the heat-shrinkable polyester film is caused to undergo heat shrinkage at a predetermined temperature T for a predetermined time t1 as shown in FIG. 6B, it is preferable that the intermediate heat shrinkage ratio rate in the main shrinkage direction (hereinafter, sometimes referred to as intermediate heat shrinkage ratio rate) is 200%/sec or less, as calculated based on the following Formula (5) from the distance change between a distance PL0 of a predetermined section before heat shrinkage, a distance PL1 of the predetermined section at a predetermined time t2, which is shorter than the predetermined time t1, and a distance PL2 of the predetermined section at a predetermined time t3, which is shorter than the predetermined time t1 and longer than the predetermined time t2.

$$Intermediate heat shrinkage ratio rate ( \% / sec ) = ( PL 1 - PL 2 ) / ( PL 0 \times ( t 3 - t 2 ) ) \times 100 \qquad ( 5 )$$

The reason for this is that, by adopting such an intermediate heat shrinkage ratio rate, the heat shrinkage rate of the heat-shrinkable polyester film can be adjusted more precisely irrespective of the size of the heat-shrinkable polyester film.

Therefore, it is more preferable that the intermediate heat shrinkage ratio rate is 180%/sec or less, and even more preferably 150%/sec or less.

On the other hand, from the viewpoint of preventing defects caused by excessively small shrinkage in a short period of time, it is preferable that the intermediate heat shrinkage ratio rate is 60%/sec or more, more preferably 80%/sec or more, and even more preferably 90%/sec or more.

Incidentally, it is preferable that the intermediate heat shrinkage ratio rate always has a positive value in the same manner as for the intermediate heat shrinkage rate; however, it has been found that even in a case where the intermediate heat shrinkage ratio rate has a negative value, there is no problem with the intended use of the heat-shrinkable polyester film so long as the value is small.

Therefore, with regard to the heat-shrinkable polyester film, it is preferable that the minimum value of the intermediate heat shrinkage ratio rate is suppressed to be −2.5%/sec or more.

It is because, by suppressing the behavior of the heat-shrinkable polyester film such that the intermediate heat shrinkage ratio rate has a negative value in this way, wrinkles and the like in the case of using the film as a heat-shrinkable polyester film can be prevented more effectively.

Therefore, it is more preferable that the minimum value of the intermediate heat shrinkage ratio rate is-1.5%/sec, and even more preferably 08/sec or more.

Furthermore, upon calculating the heat shrinkage ratio rate, it is preferable to set the predetermined times t2 and t3 to be 5 seconds or less.

The reason for this is that, by adopting such a predetermined time, the behavior of the heat-shrinkable polyester film during heat shrinkage can be measured in more detail.

Therefore, it is more preferable that the predetermined times t2 and t3 to be 4 seconds or less, and even more preferably 3 seconds or less.

Furthermore, it is preferable that the time in which the intermediate heat shrinkage ratio rate becomes maximum is 1 second or less.

The reason for this is that, by configuring the heat-shrinkable polyester film in this way, the timing at which the heat-shrinkable polyester film significantly shrinks can be controlled, and the heat shrinkage characteristics can be adjusted more precisely.

Therefore, it is more preferable that the time at which the intermediate heat shrinkage ratio rate becomes maximal is 0.8 seconds or less, and even more preferably 0.6 seconds or less.

### (7) Difference in Heat Shrinkage Ratio Rate Per Second

Furthermore, with regard to the heat-shrinkable polyester film, when a predetermined section is provided along the main shrinkage direction of the heat-shrinkable polyester film, and the film is caused to undergo heat shrinkage along the main shrinkage direction at a predetermined temperature T for a predetermined time t1, when the distance of the predetermined section before heat shrinkage is PL0, the distance of the predetermined section at a predetermined time t2, which is shorter than the predetermined time t1, is PL1, the distance of the predetermined section at a predetermined time t3, which is shorter than the predetermined time t1 and longer than the predetermined time t2, is PL2, and the measurement time t3−t2 is 1 second, it is preferable that the difference in the heat shrinkage ratio rate per second calculated based on the following Formula (6) is usually 100%/sec or less under predetermined conditions (predetermined temperature T: 70° C. to 98° C., predetermined time t1: above 5 seconds).

$$Difference in heat shrinkage ratio rate per second ( \% / sec ) = ( PL 0 - PL 1 ) / ( PL 0 \times t 2 ) \times 100 = ( PL 0 - PL 2 ) / ( PL 0 \times t 3 ) \times 100 \qquad ( 6 )$$

The reason for this is that, by taking such a difference in the heat shrinkage ratio rate, the heat-shrinkable polyester film can be caused to shrink more stably.

Therefore, it is more preferable that the difference in the heat shrinkage ratio rate is 808/sec or less, and even more preferably 50%/sec or less.

### Second Embodiment

A second embodiment is an embodiment related to a method for manufacturing the heat-shrinkable polyester film of the first embodiment by using a motion capture device.

### 1. Step of Preparing and Mixing Raw Materials

First, it is preferable that main agents and additives such as a crystalline polyester resin, a non-crystalline polyester resin, a rubber resin, an antistatic agent, and a hydrolysis preventing agent are prepared as raw materials.

Next, it is preferable that the prepared crystalline polyester resin, non-crystalline polyester resin, and the like are introduced into a stirring container while being weighed, and the materials are mixed and stirred using a stirring device until the mixture becomes uniform.

### 2. Step of Producing Raw Sheet

Next, it is preferable that the uniformly mixed raw materials are dried into an absolute dry state.

Next, typically, it is preferable that extrusion molding is carried out to produce a raw sheet having a predetermined thickness.

More specifically, for example, extrusion molding is carried out under the conditions of an extrusion temperature of 260° C. using an extruder with an L/D ratio of 24 and an extrusion screw diameter of 50 mm (manufactured by Tanabe Plastics Machinery Co., Ltd.), and a raw sheet having a predetermined thickness (usually, 10 to 100 μm) can be obtained.

### 3. Production of Heat-Shrinkable Polyester Film

Next, the obtained raw sheet is heated and pressed while being moved on rolls or between rolls using a heat-shrinkable film manufacturing apparatus, to produce a heat-shrinkable polyester film.

That is, it is preferable that polyester molecules constituting the heat-shrinkable polyester film are crystallized into a predetermined shape by stretching the film in a predetermined direction, while heating and pressing the film at a predetermined stretching temperature and a predetermined stretch ratio while basically expanding the film width.

Then, a heat-shrinkable polyester film that is used for decoration, labeling, and the like by solidifying the film in that state, can be produced.

### 4. Measurement of Heat Shrinkage Ratio Measured Using Motion Capture Device

Typically, it is preferable that measurement of the heat shrinkage ratio is carried out according to the following processes.

(1) A step of preparing a heat-shrinkable polyester film as an object to be measured is carried out.

In that case, it is preferable to check that the thickness of the heat-shrinkable polyester film has a value within a predetermined range.

Furthermore, it is preferable to measure the haze value, the glass transition point, or various thermal characteristics of the heat-shrinkable polyester film in advance.

(2) Next, as shown in FIG. 3A, a step of setting two measurement positions (P1 and P2) in the TD direction, which is the main shrinkage direction of the heat-shrinkable polyester film 10 before the film is caused to undergo heat shrinkage.

Then, the interval as a linear distance between the two measurement positions in the TD direction (P1 and P2) before the film is caused to undergo heat shrinkage, is designated as L1.

Here, with regard to the two measurement positions in the TD direction (P1 and P2), when the planar shape of the heat-shrinkable polyester film is a strip (rectangular) shape or a square shape, the measurement positions are usually provided at locations 5 mm or more away from the end parts of the film so that both end parts thereof remain free.

Furthermore, as shown in FIG. 3A, it is preferable that a step of setting two measurement positions (P3 and P4) other than the above-mentioned two measurement positions (P1 and P2) in the MD direction, which is a direction orthogonally intersecting the main shrinkage direction, is carried out.

Then, it is preferable that the interval as a linear distance between the two measurement positions in the MD direction (P3 and P4) before the film is caused to undergo heat shrinkage, is designated as L2.

Here, with regard to the two measurement positions in the MD direction (P3 and P4), when the planar shape of the heat-shrinkable polyester film is a strip (rectangular) shape or a square shape, the measurement positions are usually provided at locations 5 mm or more away from the end parts of the film, in the same manner as for the measurement positions in the TD direction.

(3) Next, a step of causing the heat-shrinkable polyester film to undergo heat shrinkage is carried out.

That is, as shown in FIGS. 2A to 2C, for example, it is preferable that a hot water bath 20 holding hot water 22 that has been maintained at a predetermined temperature by a heater 22a is prepared, and the heat-shrinkable polyester film is caused to undergo heat shrinkage in the TD direction by immersing the film in the hot water under the conditions of a heat shrinkage temperature of 70° C. to 98° C. for a shrinkage time of 1 to 60 seconds.

In that case, as shown in FIG. 2B, it is preferable that a mesh-shaped fixing jig 12 formed from, for example, stainless steel wires is prepared, and the heat-shrinkable polyester film 10 is partially accommodated inside the fixing jig so that the heat-shrinkable polyester film is uniformly immersed and heated.

In addition, it is preferable that the fixing jig 12 is provided with an opening part 12′ having a predetermined size at the locations corresponding to the measurement points P1 and P2 so that the heat-shrinkable polyester film 10 is prevented from stretching or the like in the thickness direction, and the shrinkage ratio can be measured using a motion capture device or the like.

It is preferable that at least two linear objects 26 are attached to both end parts of the heat-shrinkable polyester film 10 through the fixing jig 12 made of stainless steel, so that the heat-shrinkable polyester film is further uniformly immersed and heated for a predetermined time.

That is, it is preferable that wires and the like as these linear objects 26 are further connected to a lifter 24, and the lifter 24 is configured to be capable of moving up and down at a constant speed while maintaining the horizontal direction of the heat-shrinkable polyester film 10 by winding up or unwinding the linear objects 26.

Furthermore, as a step of causing the heat-shrinkable polyester film to undergo heat shrinkage, from the viewpoint of preventing the occurrence of temperature unevenness, as shown in FIG. 2B as an example, it is preferable that the heat-shrinkable polyester film 10 is immersed in the hot water bath 20 and caused to undergo heat shrinkage.

On the other hand, from the viewpoint of making a measurement more quickly and more simply, as shown in FIGS. 2A and 2C, it is also preferable that the heat-shrinkable polyester film 10 is floated on the surface of the hot water 22 maintained at a predetermined temperature in the hot water bath 20, and is caused to undergo heat shrinkage.

(4) Next, as shown in FIG. 3B, a step of making measurements using a motion capture device 14 is carried out by taking the interval between two measurement positions (P1′ and P2′) in the TD direction of the heat-shrinkable polyester film 10′ after heat shrinkage as a second (2^{nd}) distance.

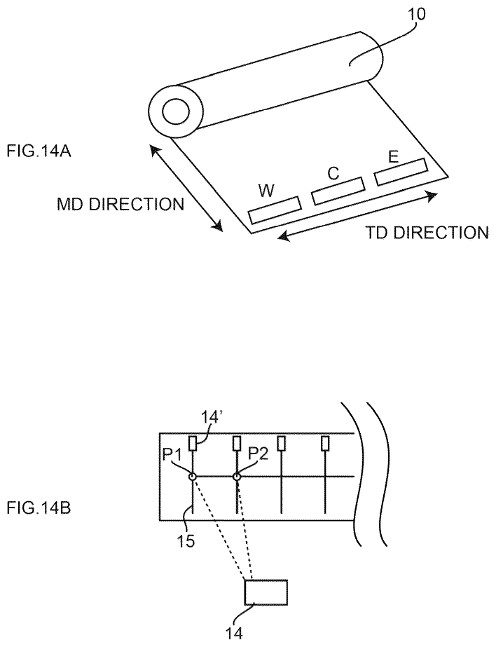

That is, as shown in FIG. 3B and FIGS. 14A and 14B, it is preferable that a predetermined motion capture device 14 and an inertial sensor 14′ are prepared, and the interval between two measurement positions in the heat-shrinkable polyester film that is caused to undergo heat shrinkage under predetermined conditions is measured as L′1 (sometimes referred to as a second (2^{nd}) distance) by using the motion capture device.

As shown in FIGS. 14A and 14B, when measurement samples are cut out from three locations (W, C, and E) along the TD direction to obtain a plurality of samples, it is preferable that predetermined markers are attached to two measurement positions of each of the measurement samples (W, C, and E), and measurements are made.

On the other hand, it is also preferable that the interval between two measurement positions of such a heat-shrinkable polyester film before heat shrinkage or during heat shrinkage is measured continuously (for example, at time intervals of 0.01 to 1 second) by using a motion capture device or the like.

Furthermore, it is preferable that the inertial sensor 14′ shown in FIGS. 14A and 14B is a combination of a long-axis sensor and several short-axis sensors intersecting the long-axis sensor at 90° at equal intervals, and at least two measurement points are provided at any position with a predetermined interval.

However, the inertial sensor 14′ is not limited to the form of a combination of these, and it is also preferable that the planar shape is at least one of a circle, a triangle, a quadrangle, a polygon, and an irregular shape.

Here, the intervals of the inertial sensors provided at predetermined intervals are measured using an inertial-type motion capture device as the motion capture device; however, it is also preferable to measure a predetermined marker such as an oil marker by using an image-type motion capture device.

Furthermore, as shown in FIG. 3B, it is preferable that a step of making measurements using a motion capture device is carried out by taking the interval between two measurement positions (P3′ and P4′) in the MD direction as a second-prime (2^{nd}′) distance, is carried out. Then, the interval as a linear distance between the two measurement positions in the MD direction (P3′ and P4′) after heat shrinkage is designated as L′2.

That is, it is preferable to measure the 2^{nd}′ distance in the MD direction in the same manner as in the measurement of the 2^{nd} distance in the TD direction.

(5) Next, a step of calculating the heat shrinkage ratio in the TD direction based on Formula (1) from L1, which is the distance between two points before heat shrinkage, and L′1, which is the distance between two points after heat shrinkage, is carried out.

Then, it is preferable to check that the heat shrinkage ratio in the TD direction in the heat-shrinkable polyester film is 20% or more.

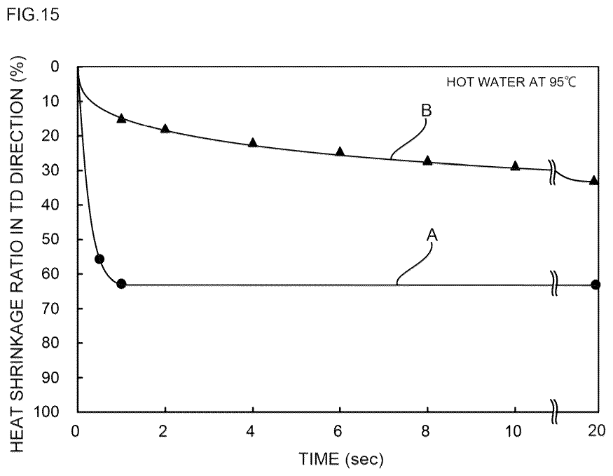

Here, referring to FIG. 15, the relation between the immersion time in a case where the film is immersed in hot water at 95° C. for 1 to 20 seconds, and the heat shrinkage ratio (%) in the TD direction measured using a motion capture device in Example 2 and Comparative Example 1 will be described.

That is, the axis of abscissa in FIG. 15 represents the immersion time (seconds), and the axis of ordinate represents the heat shrinkage ratio (%) in the TD direction measured using a motion capture device.

In the case of the characteristic curve of Example 2 (line A), when the immersion time is about 1 second, a heat shrinkage ratio (%) that is almost equal even when compared with the value obtained after a lapse of 20 seconds, is obtained.

In contrast, in the case of the characteristic curve of Comparative Example 1 (line B), when the heat shrinkage ratio (%) in the case of an immersion time of 1 second is compared with the heat shrinkage ratio in the case of an immersion time of 20 seconds, a tendency that the heat shrinkage ratio (%) increases as the immersion time is longer is obtained.

Therefore, it can be said that it is preferable to determine the immersion time by taking into consideration the PET resin used, the thickness and thermal characteristics of the resulting heat-shrinkable polyester film, as well as manufacturing conditions.

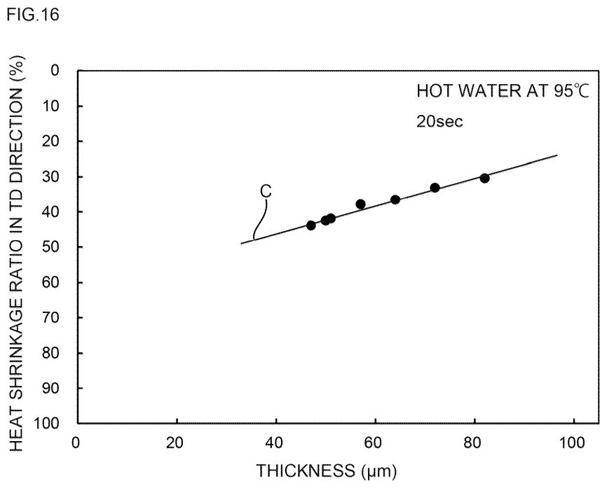

In addition, referring to FIG. 16, the relation between the thickness (μm) of the heat-shrinkable polyester film when the film is immersed in hot water at 95° C. for 20 seconds, and the heat shrinkage ratio (%) in the TD direction measured using a motion capture device, will be described.

That is, the axis of abscissa in FIG. 16 represents the thickness (μm) of the heat-shrinkable polyester film, and the axis of ordinate represents the heat shrinkage ratio (%) in the TD direction measured using a motion capture device.

Therefore, in the case of such a characteristic curve (line C), it is understood that a lower heat shrinkage ratio (%) is obtained as the thickness (μm) of the heat-shrinkable polyester film is larger, and there is a predetermined correlation (linear relationship).

Therefore, it can be said that it is preferable to adjust the heat shrinkage ratio (%) by taking into consideration the thickness and thermal characteristics of the heat-shrinkable polyester film.

Furthermore, it is preferable that a step of calculating the heat shrinkage ratio in the MD direction from L2, which is the distance between two points before heat shrinkage, and L′2, which is the distance between two points after heat shrinkage, in the same manner as for the heat shrinkage ratio in the TD direction, is carried out.

Then, it is preferable to check that the heat shrinkage ratio in the MD direction of the heat-shrinkable polyester film has a value within the range of −5% to 5%.

The reason for this is that, by simultaneously measuring the heat shrinkage ratio in the MD direction in this way, the heat shrinkage characteristics at the time of actually using the heat-shrinkable polyester film can be controlled more easily according to the use applications and the like of the heat-shrinkable polyester film.

(6) Next, it is preferable that a step of comparing the obtained data on the heat shrinkage ratio and thickness with a calibration curve is carried out.

That is, it is preferable to check that the values of the thickness of the heat-shrinkable polyester film checked in step (1) and the heat shrinkage ratio obtained in step (5) each match to a previously prepared calibration curve showing the relation between the thickness of the heat-shrinkable polyester film and the heat shrinkage ratio measured using a motion capture device.

(7) Next, it is also preferable that a predetermined adjustment step is carried out.

That is, when the heat shrinkage ratio in the TD direction seems to be below 20%, it is preferable that the heat shrinkage ratio is adjusted to be within a predetermined range by reducing the thickness of the heat-shrinkable polyester film, or changing the raw materials of the heat-shrinkable polyester film or the manufacturing conditions.

(8) Next, it is preferable to have a step of adjusting the standard deviation of the heat shrinkage ratio as another predetermined adjustment step.

That is, when the standard deviation of the heat shrinkage ratio in the TD direction is above 15%, it is preferable to adjust the standard deviation of the heat shrinkage ratio to be within a predetermined range by reducing the thickness of the heat-shrinkable polyester film, or changing the raw materials of the heat-shrinkable polyester film or the manufacturing conditions.

(9) Next, it is preferable that a step of calculating other heat shrinkage characteristics in the first embodiment, such as the heat shrinkage ratio, the standard deviation of the heat shrinkage rate, the intermediate heat shrinkage rate, the intermediate heat shrinkage ratio rate, and the difference in the intermediate heat shrinkage ratio rate per second, by using a motion capture device, is included as another step.

Then, it is preferable that a step of adjusting each of the measured values to be within a predetermined range is included.

(10) Lastly, it is also preferable that other examination steps are carried out.

That is, it is preferable that predetermined inspection steps are provided to measure the following characteristics and the like continuously or intermittently for the produced heat-shrinkable polyester film.

By measuring the following characteristics and the like through such predetermined examination steps, and checking whether the characteristics and the like have values within predetermined ranges, a heat-shrinkable polyester film having more uniform shrinkage characteristics and the like can be obtained.
1) Examination by visual inspection of the appearance of the heat-shrinkable polyester film
2) Measurement of variation in thickness
3) Measurement of haze value
4) Measurement of glass transition point
5) Measurement of melting point and heat of fusion
6) Measurement of tensile modulus
7) Measurement of tear strength
8) Measurement of viscoelastic characteristics using SS curve

### Third Embodiment

A third embodiment is an embodiment related to a method of using a heat-shrinkable polyester film having a heat shrinkage ratio measured using a motion capture device.

That is, any known method of using a heat-shrinkable film can all be suitably applied.

For example, when carrying out the method of using a heat-shrinkable polyester film, first, the heat-shrinkable polyester film is cut to an appropriate length or width, and at the same time, a long cylindrical-shaped object is formed.

Next, the long cylindrical-shaped object is fed to an automatic label attaching apparatus (shrink labeler), cut to a required length, and fitted onto the outside of a PET bottle or the like filled with contents.

Next, as a heating treatment of the heat-shrinkable polyester film fitted onto the outside of a PET bottle or the like, the heat-shrinkable polyester film is passed through the inside of a hot air tunnel or a steam tunnel at a predetermined temperature.

Then, the heat-shrinkable polyester film is uniformly heated and caused to undergo heat shrinkage, by radiating radiant heat such as infrared rays provided by these tunnels, or blowing heated steam at about 90° C. from the surroundings.

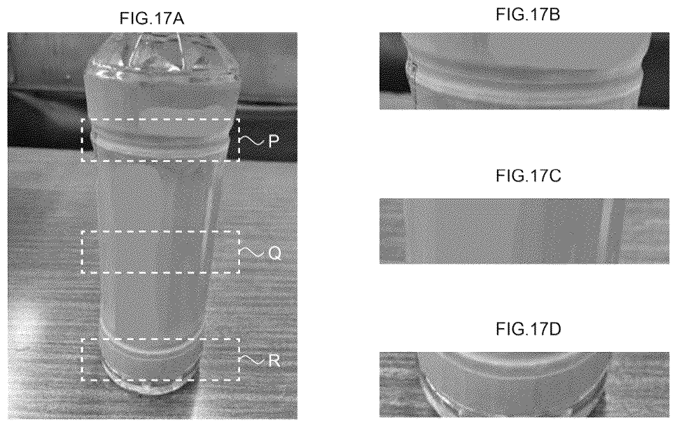

Therefore, when the heat shrinkage ratio in the TD direction is 20% or more, as shown in FIGS. 17A to 17D, a labeled container can be quickly obtained by adhering the heat-shrinkable polyester film tightly to the outer surface of a PET bottle or the like.

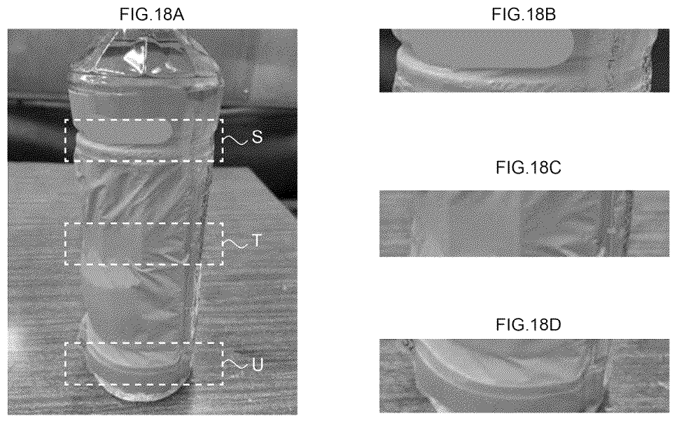

On the other hand, when the heat shrinkage ratio in the TD direction is below 20%, as shown in FIGS. 18A to 18D, regions where the label could not follow the shape of the bottle periphery occur from the top to the bottom of the bottle body, and the occurrence of wrinkles is also noticeably observed.

### EXAMPLES

Hereinafter, the present invention will be described in detail based on Examples. However, the scope of rights of the present invention will not be narrowed by the description of Examples without any particular reason.

Incidentally, the polyester resins used in Example 1 and the like are as follows.

### (PETG1)

A non-crystalline polyester composed of dicarboxylic acid: 100 mol % of terephthalic acid, diol: 69 mol % of ethylene glycol, 20 mol % of 1,4-cyclohexanedimethanol, and 11 mol % of diethylene glycol (glass transition point: 69° C.)

### (PETG2)

A non-crystalline polyester composed of dicarboxylic acid: 100 mol % of terephthalic acid, diol: 63 mol % of ethylene glycol, 24 mol % of 1,4-cyclohexanedimethanol, and 13 mol % of diethylene glycol (glass transition point: 69° C.)

### (PETG3)

A non-crystalline polyester composed of dicarboxylic acid: 100 mol % of terephthalic acid, diol: 68 mol % of ethylene glycol, 30 mol % of neopentyl glycol, and 2 mol % of diethylene glycol (glass transition point: 75° C.)

### (PETG4)

A non-crystalline polyester composed of dicarboxylic acid: 100 mol % of terephthalic acid, diol: 70 mol % of ethylene glycol, 28 mol % of 1,4-cyclohexanedimethanol, and 2 mol % of diethylene glycol (glass transition point: 69° C.)

### Example 1

### 1. Production of Heat-Shrinkable Polyester Film

A non-crystalline polyester resin (PETG1) was used at a proportion of 100 parts by weight (pbw) in a stirring container.

Next, this raw material was dried into an absolute dry state and then subjected to extrusion molding under the condition of an extrusion temperature of 260° C. by using an extruder (manufactured by Tanabe Plastics Machinery Co., Ltd.) with an L/D ratio of 24 and an extrusion screw diameter of 50 mm, to obtain a raw sheet having a thickness of 200μ m.

Next, a heat-shrinkable polyester film having a thickness of 40 μm was produced from the raw sheet by using a heat-shrinkable film manufacturing apparatus, at a preheating temperature of 75° C., a stretching temperature of 75° C., stretch ratios (MD direction: 105%, TD direction: 500%), and a thermal fixing temperature of 60° C.

### 2. Evaluation of Heat-Shrinkable Polyester Film

### (1) Evaluation 1: Variation in Thickness

The thickness of the obtained heat-shrinkable polyester film was measured (n=6) by using a micrometer and evaluated according to the following criteria as EVA 1.
⊙ (Very good): The variation in thickness has a value of 3 μm or less.
◯ (Good): The variation in thickness has a value of 5 μm or less.
Δ (Fair): The variation in thickness has a value of 10 μm or less.
X (Bad): The variation in thickness has a value of above 10 μm.

### (2) Evaluation 2: Heat Shrinkage Ratio in TD Direction (A1)

The obtained heat-shrinkable polyester film was immersed in hot water at 95° C. for 1 second by using a hot water bath to cause the film to undergo heat shrinkage.

Next, as shown in FIG. 2A, the heat shrinkage ratio in the TD direction (A1) was calculated from a distance change of markers obtained before and after a heating treatment using an image-type motion capture device 14 according to Formula (1) while capturing image data with an optical camera, and the heat shrinkage ratio was evaluated according to the following criteria as EVA 2.
⊙ (Very good): The heat shrinkage ratio (A1) has a value within the range of 50% to below 85%.
◯ (Good): The heat shrinkage ratio (A1) has a value of 30% to below 50%, or 85% to below 90%.
Δ (Fair): The heat shrinkage ratio (A1) has a value of 20% to below 30%, or 90% to below 95%.
X (Bad): The heat shrinkage ratio (A1) has a value of below 20% or above 95%.

### (3) Evaluation 3: Standard Deviation (σ1) of Heat Shrinkage Ratio in TD Direction (A1)

The standard deviation (σ1) was calculated from the values (n=6) of the heat shrinkage ratio in the TD direction (A1) obtained in Evaluation 2 using an image-type motion capture device, and was evaluated according to the following criteria as EVA 3.
⊙ (Very good): The standard deviation of the heat shrinkage ratio (A1) is 5% or less.
◯ (Good): The standard deviation of the heat shrinkage ratio (A1) is 10% or less.
Δ (Fair): The standard deviation of the heat shrinkage ratio (A1) is 15% or less.
X (Bad): The standard deviation of the heat shrinkage ratio (A1) is above 20%.

### (4) Evaluation 4: Heat Shrinkage Ratio in TD Direction (A′1)

The obtained heat-shrinkable polyester film was immersed in hot water at 95° C. for 10 seconds by using a hot water bath to cause the film to undergo heat shrinkage.

Next, a dimensional change before and after a heating treatment were calculated based on the data, and the heat shrinkage ratio in the TD direction (A′1) was calculated according to Formula (1) and evaluated according to the following criteria as EVA 4.
⊙ (Very good): The heat shrinkage ratio (A′1) has a value within the range of 70% to 85%.
◯ (Good): The heat shrinkage ratio (A′1) has a value of 65% to below 70%, or 85% to below 90%.
Δ (Fair): The heat shrinkage ratio (A′1) has a value of 60% to below 65%, or 90% to below 95%.
X (Bad): The heat shrinkage ratio (A′1) has a value of below 60% or above 95%.

### (5) Evaluation 5: Haze Value

For the obtained heat-shrinkable polyester film, the haze value was measured according to JIS K 7105 and evaluated according to the following criteria.
⊙ (Very good): The haze value is 3% or less.
◯ (Good): The haze value is 5% or less.
Δ (Fair): The haze value is 7% or less.
X (Bad): The haze value is above 7%.

### (6) Evaluation 6: Heat Shrinkage Ratio in TD Direction (A2)

The obtained heat-shrinkable polyester film was immersed in hot water at 80° C. for 1 second by using a hot water bath to cause the film to undergo heat shrinkage.

Next, as shown in FIG. 2A, the heat shrinkage ratio in the TD direction (A2) was calculated from a distance change of markers obtained before and after a heating treatment using an image-type motion capture device 14 according to Formula (1) while capturing image data with an optical camera, and the heat shrinkage ratio was evaluated according to the following criteria as EVA 6.
⊙ (Very good): The heat shrinkage ratio (A2) has a value within the range of 20% to below 50%.
◯ (Good): The heat shrinkage ratio (A2) has a value of 15% to below 20%, or 50% to below 70%.
Δ (Fair): The heat shrinkage ratio (A2) has a value of 10% to below 15%, or 70% to below 80%.
X (Bad): The heat shrinkage ratio (A2) has a value of below 10% or above 80%.

### (7) Evaluation 7: Standard Deviation (σ2) of Heat Shrinkage Ratio in TD Direction (A2)

The standard deviation (σ2) was calculated from the values (n=6) of the heat shrinkage ratio in the TD direction (A2) obtained in Evaluation 6 using an image-type motion capture device, and was evaluated according to the following criteria as EVA 7.
⊙ (Very good): The standard deviation of the heat shrinkage ratio (A2) is 4% or less.
◯ (Good): The standard deviation of the heat shrinkage ratio (A2) is 8% or less.
Δ (Fair): The standard deviation of the heat shrinkage ratio (A2) is 12% or less.
X (Bad): The standard deviation of the heat shrinkage ratio (A2) is above 16%.

### (8) Evaluation 8: Heat Shrinkage Ratio in TD Direction (A′2)

The obtained heat-shrinkable polyester film was immersed in hot water at 80° C. for 10 seconds by using a hot water bath to cause the film to undergo heat shrinkage.

Next, as shown in FIG. 2A, the heat shrinkage ratio in the TD direction (A′2) was calculated from a distance change of markers obtained before and after a heating treatment using an image-type motion capture device 14 according to Formula (1) while capturing image data with an optical camera, and the heat shrinkage ratio was evaluated according to the following criteria as EVA 8.
⊙ (Very good): The heat shrinkage ratio (A′2) has a value within the range of 30% to below 65%.
◯ (Good): The heat shrinkage ratio (A′2) has a value of 20% to below 30%, or 65% to below 75%.
Δ (Fair): The heat shrinkage ratio (A′2) has a value of 10% to below 20%, or 75% to below 85%.
X (Bad): The heat shrinkage ratio (A′2) has a value of below 10% or above 85%.
   (9) Evaluation 9: Standard deviation (σ′2) of heat shrinkage ratio in TD direction (A′2)

The standard deviation (σ′2) was calculated from the values (n=6) of the heat shrinkage ratio in the TD direction (A′2) obtained in Evaluation 8 using an image-type motion capture device, and was evaluated according to the following criteria as EVA 9.
⊙ (Very good): The standard deviation of the heat shrinkage ratio (A′2) is 2.5% or less.
◯ (Good): The standard deviation of the heat shrinkage ratio (A′2) is 5% or less.
Δ (Fair): The standard deviation of the heat shrinkage ratio (A′2) is 7.5% or less.
X (Bad): The standard deviation of the heat shrinkage ratio (A′2) is above 10%.

### (10) Evaluation 10: Heat Shrinkage Rate

The obtained heat-shrinkable polyester film was floated on hot water at 80° C. for 10 seconds by using a hot water bath and was caused to undergo heat shrinkage while being measured for 10 seconds or more using an image-type motion capture device.

That is, the heat shrinkage rate in the main shrinkage direction was calculated according to Formula (2) from a distance change of predetermined markers before and after a predetermined time obtained using an image-type motion capture device while capturing image data with an optical camera, and the heat shrinkage rate was evaluated according to the following criteria as EVA 10.

At this time, upon calculating the heat shrinkage rate, the distance PL0 of a predetermined section before heat shrinkage was 10 mm, and measurements were made at intervals of 0.1 seconds.
⊙ (Very good): The heat shrinkage rate is 4 mm/sec or more.
◯ (Good): The heat shrinkage rate is 3 mm/sec or more and below 4 mm/sec.
Δ (Fair): The heat shrinkage rate is 2 mm/sec or more and below 3 mm/sec.
X (Bad): The heat shrinkage rate is below 2 mm/sec.

### (11) Evaluation 11: Minimum Value of Intermediate Heat Shrinkage Rate

The obtained heat-shrinkable polyester film was floated on hot water at 80° C. for 10 seconds by using a hot water bath to cause the film to undergo heat shrinkage.

Next, the intermediate heat shrinkage rate was determined according to Formula (4) from the heat shrinkage ratios (number of predetermined sections n=6) in the main shrinkage direction obtained using an image-type motion capture device while capturing image data with an optical camera, and from the minimum value of the intermediate heat shrinkage rate in the section with the largest maximum value of the intermediate heat shrinkage rate among the predetermined sections, the intermediate heat shrinkage rate was evaluated according to the following criteria as EVA 11.

At this time, upon calculating the intermediate heat shrinkage rate, the distance PL0 of a predetermined section before heat shrinkage was 10 mm, and measurements were made by taking the measurement period t3−t2 as 0.1 seconds.
⊙ (Very good): The minimum value of the intermediate heat shrinkage rate is 0 mm/sec or more.
◯ (Good): The minimum value of the intermediate heat shrinkage rate is −1.5 mm/sec or more.
Δ (Fair): The minimum value of the intermediate heat shrinkage rate is −2.5 mm/sec or more.
X (Bad): The minimum value of the intermediate heat shrinkage rate is below −2.5 mm/sec.

### Example 2

### 1. Production of Heat-Shrinkable Polyester Film

In Example 2, a raw sheet having a thickness of 200 μm was obtained in the same manner as in Example 1, except that 100 parts by weight of a non-crystalline polyester resin (PETG2) was used in a stirring container, as shown in Table 1.

Next, a heat-shrinkable polyester film having a thickness of 40 μm was produced from the raw sheet by using a heat-shrinkable film manufacturing apparatus, at a preheating temperature of 75° C., a stretching temperature of 75° C., stretch ratios (MD direction: 105%, TD direction: 500%), and a thermal fixing temperature of 60° C.

### 2. Evaluation of Heat-Shrinkable Polyester Film

In Example 2, the variation in thickness (Evaluation 1) of the obtained heat-shrinkable polyester film, the heat shrinkage ratio in the TD direction obtained using an image-type motion capture device (Evaluation 2 and Evaluation 4), the standard deviation of the heat shrinkage ratio in the TD direction obtained using an image-type motion capture device (Evaluation 3), and the like were measured and then evaluated in the same manner as in Example 1. The results are shown in Table 2 and Table 3.

### Comparative Example 1

### 1. Production of Heat-Shrinkable Polyester Film

In Comparative Example 1, a raw sheet having a thickness of 200 μm was obtained in the same manner as in Example 1, except that 50 parts by weight of a non-crystalline polyester resin (PETG3) and 50 parts by weight of a non-crystalline polyester resin (PETG4) were used in a stirring container, as shown in Table 1.

Next, a heat-shrinkable polyester film having a thickness of 40 μm was produced from the raw sheet by using a heat-shrinkable film manufacturing apparatus, at a preheating temperature of 90° C., a stretching temperature of 90° C., stretch ratios (MD direction: 105%, TD direction: 500%), and a thermal fixing temperature of 60° C.

### 2. Evaluation of Heat-Shrinkable Polyester Film

In Comparative Example 1, the variation in thickness (Evaluation 1) of the obtained heat-shrinkable polyester film, the heat shrinkage ratio in the TD direction obtained using an image-type motion capture device (Evaluation 2 and Evaluation 4), the standard deviation of the heat shrinkage ratio in the TD direction obtained using an image-type motion capture device (Evaluation 3), and the like were evaluated in the same manner as in Example 1. The results are shown in Table 2 and Table 3.

### Comparative Example 2

### 1. Production of Heat-Shrinkable Polyester Film

In Comparative Example 2, a raw sheet having a thickness of 200 μm was obtained in the same manner as in Example 1, except that 100 parts by weight of a non-crystalline polyester resin (PETG4) were used in a stirring container, as shown in Table 1.

Next, a heat-shrinkable polyester film having a thickness of 40 μm was produced from the raw sheet by using a heat-shrinkable film manufacturing apparatus, at a preheating temperature of 90° C., a stretching temperature of 90° C., stretch ratios (MD direction: 105%, TD direction: 500%), and a thermal fixing temperature of 60° C.

### 2. Evaluation of Heat-Shrinkable Polyester Film

In Comparative Example 2, the variation in thickness (Evaluation 1) of the obtained heat-shrinkable polyester film, the heat shrinkage ratio in the TD direction obtained using an image-type motion capture device (Evaluation 2 and Evaluation 4), the standard deviation of the heat shrinkage ratio in the TD direction obtained using an image-type motion capture device (Evaluation 3), and the like were evaluated in the same manner as in Example 1. The results are shown in Table 2 and Table 3.

### Comparative Example 3

### 1. Production of Heat-Shrinkable Polyester Film

In Comparative Example 3, a raw sheet having a thickness of 200 μm was obtained in the same manner as in Example 1, except that 100 parts by weight of a non-crystalline polyester resin (PETG3) were used in a stirring container, as shown in Table 1.

Next, a heat-shrinkable polyester film having a thickness of 40 μm was produced from the raw sheet by using a heat-shrinkable film manufacturing apparatus, at an extrusion temperature of 260° C., a preheating temperature of 90° C., a stretching temperature of 90° C., stretch ratios (MD direction: 105%, TD direction: 500%), and a thermal fixing temperature of 60° C.

### 2. Evaluation of Heat-Shrinkable Polyester Film

In Comparative Example 3, the variation in thickness (Evaluation 1) of the obtained heat-shrinkable polyester film, the heat shrinkage ratio in the TD direction obtained using an image-type motion capture device (Evaluation 2 and Evaluation 4), the standard deviation of the heat shrinkage ratio in the TD direction obtained using an image-type motion capture device (Evaluation 3), and the like were evaluated in the same manner as in Example 1. The results are shown in Table 2 and Table 3.

TABLE 1

| | | | Conditions for stretching in TD direction | | | | |
|---|---|---|---|---|---|---|---|
| | | | | | | Thermal | Glass |
| | | Extrusion | Preheating | Stretch | Stretching | fixing | transition |
| | | temperature | temperature | ratio | temperature | temperature | point |
| | Resin | (° C.) | (° C.) | (%) | (° C.) | (° C.) | (° C.) |
| Example 1 | PETG1 | 260 | 75 | 500 | 75 | 60 | 69 |
| Example 2 | PETG2 | 260 | 75 | 500 | 75 | 60 | 69 |
| Comparative | PETG3 (50%) | 260 | 90 | 500 | 90 | 60 | 72 |
| Example 1 | PETG4 (50%) | | | | | | |
| Comparative | PETG4 | 260 | 90 | 500 | 90 | 60 | 69 |
| Example 2 | | | | | | | |
| Comparative | PETG3 | 260 | 90 | 500 | 90 | 60 | 75 |
| Example 3 | | | | | | | |

TABLE 2

| | EVA 1 | EVA 2 | EVA 3 | EVA 4 | EVA 5 |
|---|---|---|---|---|---|
| Example 1 | Very | Very | Very | Very | Very |
| | good | good | good | good | good |
| Example 2 | Good | Very | Very | Very | Good |
| | | good | good | good | |
| Comparative | Bad | Bad | Good | Fair | Very |
| Example 1 | | | | | good |
| Comparative | Bad | Bad | Good | Fair | Very |
| Example 2 | | | | | good |
| Comparative | Fair | Bad | Very | Good | Very |
| Example 3 | | | good | | good |

EVA 1: Variation in thickness,
EVA 2: A1,
EVA 3: σ1,
EVA 4: A′1,
EVA 5: Haze value

TABLE 3

| | EVA 6 | EVA 7 | EVA 8 | EVA 9 | EVA 10 | EVA 11 |
|---|---|---|---|---|---|---|
| Example 1 | Very | Very | Very | Very | Very | Good |
| | good | good | good | good | good | |
| Example 2 | Very | Very | Very | Very | Good | Good |
| | good | good | good | good | | |
| Comparative | Very | Good | Very | Very | Fair | Fair |
| Example 1 | good | | good | good | | |
| Comparative | Very | Good | Very | Very | Fair | Fair |
| Example 2 | good | | good | good | | |
| Comparative | Bad | Fair | Very | Very | Bad | Bad |
| Example 3 | | | good | good | | |

EVA 6: A2,
EVA 7: σ2,
EVA 8: A′2,
EVA 9: σ′2,
EVA 10: Heat shrinkage rate,
EVA 11: Minimum value of intermediate heat shrinkage rate

### INDUSTRIAL APPLICABILITY

According to the present invention, a heat-shrinkable polyester film and the like exhibiting excellent wrinkle resistance characteristics can be quickly and precisely evaluated and provided by limiting at least the heat shrinkage ratio and the like measured under predetermined conditions, to values within predetermined ranges using a motion capture device.

Therefore, the heat-shrinkable polyester film of the present invention can be applied to various PET bottles and the like, general-purpose usability can be markedly expanded, and it can be said that industrial applicability of the film is extremely high.

1. A heat-shrinkable polyester film having a predetermined heat shrinkage ratio obtained using a motion capture device,
wherein when two measurement positions are set in a TD direction, which is a main shrinkage direction of the heat-shrinkable polyester film as an object to be measured, an interval between the two measurement positions is designated as L1, and an interval of the two measurement positions after the heat-shrinkable polyester film is caused to undergo heat shrinkage, which is measured using the motion capture device, is designated as L′1,
a heat shrinkage ratio (temperature: 70° C. to 98° C., time: 1 to 60 seconds) in the main shrinkage direction of the heat-shrinkable polyester film as calculated based on the following Formula (1) is 20% or more:
$$Heat shrinkage ratio in TD direction ( \% ) = ( L 1 - {L}^{′} 1 ) / L 1 \times 100. \qquad ( 1 )$$

2. The heat-shrinkable polyester film according to claim 1, wherein a standard deviation of the heat shrinkage ratio is 15% or less.

3. The heat-shrinkable polyester film according to claim 1, wherein a thickness of the heat-shrinkable polyester film is within a range of 10 to 200 μm, and a difference between a maximum value of the thickness and an average value of the thickness is 10 μm or less.

4. The heat-shrinkable polyester film according to claim 1, wherein the two measurement positions are set at a plurality of sites, and an average value of the heat shrinkage ratio in the TD direction obtained at the plurality of sites is defined as the heat shrinkage ratio in the TD direction.

5. The heat-shrinkable polyester film according to claim 1, wherein the motion capture device is an image-type motion capture device detecting information from a predetermined marker.

6. The heat-shrinkable polyester film according to claim 1, wherein the motion capture device includes a camera for recording a state of heat shrinkage of the heat-shrinkable polyester film.

7. The heat-shrinkable polyester film according to claim 1, wherein a heat shrinkage ratio of the heat-shrinkable polyester film is measured based on at least one heat shrinking device selected from a constant temperature bath, a steam bath, a hot water bath, a liquid bath of a fluorine-containing compound, a steam bath of a fluorine-containing compound, and an infrared ray irradiating apparatus.

8. The heat-shrinkable polyester film according to claim 1, wherein a heat shrinkage ratio in a direction orthogonally intersecting a main shrinkage direction of the heat-shrinkable polyester film as the object to be measured, is measured as a heat shrinkage ratio in an MD direction using the motion capture device simultaneously with measurement of the heat shrinkage ratio in the TD direction, and the heat shrinkage ratio in the MD direction has a value within a range of −5% to 5%.

9. The heat-shrinkable polyester film according to claim 1, wherein a calibration curve showing a relation between a heat shrinkage temperature and a heat shrinkage time in a main shrinkage direction of the heat-shrinkable polyester film as the object to be measured, and the heat shrinkage ratio in the TD direction, is prepared in advance, the calibration curve and a heat shrinkage ratio obtained based on the Formula (1) are compared and verified, and the heat shrinkage ratio obtained based on the Formula (1) has a value within ±10% of the heat shrinkage ratio in the TD direction obtained from the calibration curve.
